(19) United States
(12) Patent Application Publication
(10) Pub. No.: US 2019/0349872 A1
(43) Pub. Date: Nov. 14, 2019

(54) USER TERMINAL AND RADIO COMMUNICATION METHOD

(71) Applicant: NTT DOCOMO, INC., Tokyo (JP)

(72) Inventors: Hiroki Harada, Tokyo (JP); Kazuki Takeda, Tokyo (JP); Satoshi Nagata, Tokyo (JP)

(73) Assignee: NTT DOCOMO, INC., Tokyo (JP)

(21) Appl. No.: 16/337,448

(22) PCT Filed: Sep. 29, 2017
(86) PCT No.: PCT/JP2017/035390

§ 371 Date: Mar. 28, 2019

(30) Foreign Application Priority Data
Sep. 29, 2016 (JP) 2016-192337

(51) Int. Cl. H04W 56/00; H04W 72/04; H04L 5/00; H04W 24/10; H04B 7/06; H04B 7/0456

(52) U.S. Cl. CPC H04W 56/001; H04W 72/0446; H04L 5/0082; H04B 7/0456; H04W 24/10; H04B 7/0617; H04L 5/0051

(57) ABSTRACT

To properly perform user terminal operation such as initial access, even in the case of applying beam forming, a terminal has a receiving section that receives a synchronization signal and a broadcast channel allocated to at least one of a plurality of time regions constituting a given transmission time interval, and a control section that controls reception of the synchronization signal and the broadcast channel, where the control section controls reception processing, while assuming that the synchronization signal and the broadcast channel are allocated to the same time region in different transmission time intervals.

### TECHNICAL FIELD

The present invention relates to a user terminal and radio communication method in the next-generation mobile communication system.

### BACKGROUND ART

In UMTS (Universal Mobile Telecommunications System) networks, for the purpose of higher data rates, low delay and the like, Long Term Evolution (LTE) has been specified (Non-patent Document 1). Further, for the purpose of wider bands and higher speed than LTE (also referred to as LTE Rel.8 or 9), LTE-A (LTE-Advanced, also referred to as LTE Rel.10, 11, 12 or 13) has been specified, and successor systems (e.g., also referred to as FRA (Future Radio Access), 5G (5th Generation mobile communication SYSTEM), NR (New Radio), NX (New radio access), FX (Future Generation Radio access), LTE Rel.14 or 15 onward, etc.) to LTE have been studied.

In LTE Rel.10/11, in order to widen the band, introduced is Carrier Aggregation (CA) for aggregating a plurality of component carriers (CC: CompoNeNt Carrier). Each CC is configured with a system band of LTE Rel.8 as one unit. Further, in CA, a plurality of CCs of the same radio base station (eNB: eNodeB) is configured for a user terminal (UE: User Equipment).

On the other hand, in LTE Rel.12, Dual Connectivity (DC) is also introduced where a plurality of cell groups (CG: Cell Group) of different radio base stations is configured for UE. Each cell group is comprised of at least a single cell (CC). In DC, since a plurality of CCs of different radio base stations is aggregated, DC is also called inter-base station CA (Inter-eNB CA) and the like.

Further, in the existing LTE system (e.g., LTE Rel.8-13), synchronization signals (PSS, SSS) for a user terminal to use in initial access operation, broadcast channel (PBCH) and the like are assigned to beforehand fixedly defined regions. A user terminal detects the synchronization signal by cell search, thereby acquires synchronization with the network, and is capable of identifying the cell (e.g., cell ID) for the user terminal to connect. Further, by receiving the broadcast channel (PBCH, SIB) after the cell search, the terminal is capable of acquiring system information.

### CITATION LIST

### Non-Patent Document

[Non-patent Document 1] 3GPP TS 36.300 “Evolved Universalterrestrial Radio Access (E-UTRA) and Evolved Universalterrestrial Radio Access Network (E-UTRAN); Overall Description; Stage 2”

### SUMMARY OF INVENTION

### Technical Problem

In future radio communication systems (e.g., 5G, NR), it is expected to actualize various radio communication services so as to meet respective different requirements (e.g., ultra-high speed, high capacity, ultra-low delay, etc.).

For example, in NR, it is studied to offer radio communication services called eMBB (Enhanced Mobile Broad Band), IoT (Internet of Things), MTC (Machine Type Communication), M2M (Machine to Machine), URLLC (Ultra Reliable and Low Latency Communications) and the like. In addition, M2M may be called D2D (Device To Device), V2V (Vehicle To Vehicle) and the like corresponding to equipment to communicate. In order to meet requirements for above-mentioned various communications, it is studied to design new communication access technology (New RAT (Radio Access Technology)).

In NR, for example, it is studied to offer services using 100 GHz that is an extremely high carrier frequency. Generally, as the carrier frequency increases, it is more difficult to secure coverage. The reason is caused by that distance attenuation is severe to strengthen straightness of radio wave, and that the transmit power density is lowered due to ultra-wide band transmission.

Therefore, in order to meet requirements for above-mentioned various communications also in a high-frequency band, it is studied to use Massive MIMO (Massive MIMO (Multiple Input Multiple Output)) using an ultra-multi-element antenna. In the ultra-multi-element antenna, by controlling amplitude and/or phase of a signal transmitted/received to/from each element, it is possible to form beams (antenna directivity). The processing is also called beam forming (BF), and enables radio wave propagation loss to be reduced.

On the other hand, in the case of applying beam forming, it becomes a problem how to control initial access operation (e.g., reception of synchronization signal and/or broadcast channel, etc.) of a user terminal. As in the existing LTE system, in the case of allocating the synchronization signal and broadcast channel to beforehand fixedly defined regions, there is the risk that it is not possible to flexibly control transmission/reception using a plurality of beams.

The present invention was made in view of such a respect, and it is an object of the invention to provide a user terminal and radio communication method capable of properly performing user terminal operation such as initial access, even in the case of applying beam forming.

### Solution to Problem

A user terminal according to one aspect of the present invention is characterized by having a receiving section that receives a synchronization signal and a broadcast channel allocated to at least one of a plurality of time regions constituting a given transmission time interval, and a control section that controls reception of the synchronization signal and the broadcast channel, where the control section controls reception processing, while assuming that the synchronization signal and the broadcast channel are allocated to the same time region in different transmission time intervals.

### Advantageous Effect of the Invention

According to the present invention, also in the case of applying beam forming, it is possible to properly perform user terminal operation such as initial access.

### BRIEF DESCRIPTION OF DRAWINGS

FIGS. 1A and 1B are conceptual explanatory diagrams of beam specific signal transmission;

FIGS. 2A and 2B are conceptual explanatory diagrams of single BF operation and multiple BF operation;

FIG. 3A is a diagram where PSS, SSS and PBCH are allocated to contiguous symbols; FIG. 3B is a diagram where PSS, SSS and PBCH are allocated to frequency regions on the same symbol;

FIG. 4A is a diagram illustrating resource allocation of PSS/SSS and PBCH by Aspect 1; FIG. 4B is a diagram illustrating resource allocation of PSS/SSS and PBCH with Norma CP applied; FIG. 4C is a diagram illustrating resource allocation of PSS/SSS and PBCH with extended CP applied;

FIG. 5 is a diagram illustrating resource allocation of PSS/SSS and PBCH by Aspect 2;

FIG. 6 is a diagram illustrating resource allocation of PSS, SSS and PBCH by Aspect 3;

FIG. 7 is a diagram illustrating resource allocation where PSS/SSS and PBCH are mapped from last OFDM symbols;

FIG. 8 is a diagram showing one example of a schematic configuration of a radio communication system according to one Embodiment of the present invention;

FIG. 9 is a diagram showing one example of an entire configuration of a radio base station according to one Embodiment of the invention;

FIG. 10 is a diagram showing one example of a function configuration of the radio base station according to one Embodiment of the invention;

FIG. 11 is a diagram showing one example of an entire configuration of a user terminal according to one Embodiment of the invention;

FIG. 12 is a diagram showing one example of a function configuration of the user terminal according to one Embodiment of the invention; and

FIG. 13 is a diagram showing one example of hardware configurations of the radio base station and user terminal according to one Embodiment of the invention.

### DESCRIPTION OF EMBODIMENTS

Also in future radio communication systems, it is considered that a user terminal performs detection of a signal for synchronization and demodulation of a channel for transmitting broadcast information, as in the existing LTE system, as initial access processing on a newly introduced carrier (also called NR carrier (cell)). For example, by detecting a synchronization signal, the user terminal is capable of detecting at least time frequency synchronization and cell identifier (cell ID). Further, after acquiring synchronization with the network, and further acquiring the cell ID, the user terminal is considered receiving a broadcast channel (e.g., PBCH) including system information.

Subsequent to detection of the synchronization signal and demodulation of the broadcast channel, for example, the terminal performs reception of SIB (System Information Block), PRACH (Physical Random Access Channel) transmission and the like. Therefore, it is necessary to acquire information on time resource positions (slot number, subframe number and/or radio frame timing) in which SIB reception and PRACH transmission is performed. In order to acquire these pieces of information, it is required to recognize the slot number, symbol index in the subframe, and radio frame number (SFN) of the detected synchronization signal or PBCH. Further, in the case of supporting a plurality of CP length configurations (Normal CP and Extended CP, etc.), there is a possibility that it is necessary to also recognize CP length information applied by the NR carrier (cell).

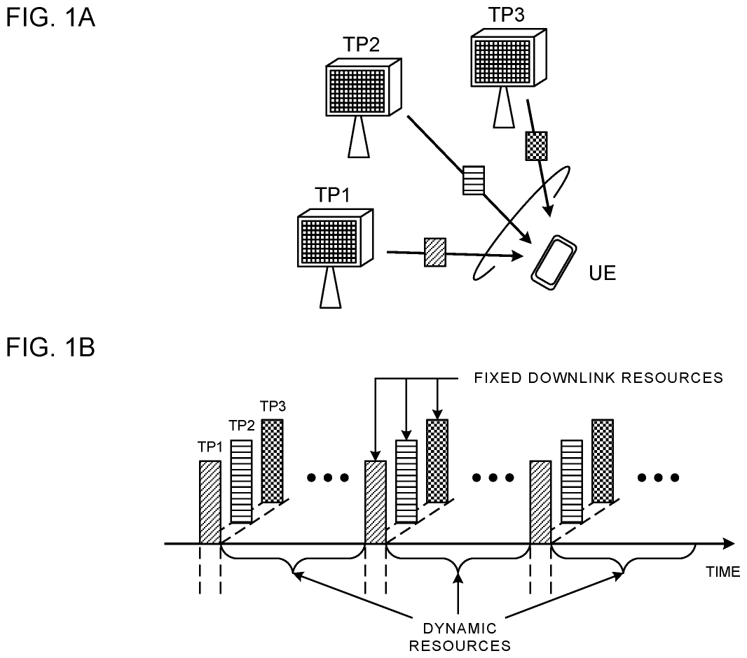

In addition, in the NR carrier (cell), it is studied to transmit the synchronization signal, PBCH (MIB, Essential System Information), reference signals for Measurement and the like in periodical fixed downlink resources. FIGS. 1A and 1B illustrate the case where three transmission points TP1, TP2, TP3 transmit, to a user terminal, beam specific signals in downlink resources fixedly configured according to a predetermined period.

As shown in FIG. 1B, by matching timing of fixed downlink resources with peripheral cells (TP), since interference to the synchronization signal, PBCH and the like is settled, it is possible to guarantee detection accuracy and measurement accuracy of these signals. Further, by collecting signals necessary to transmit periodically in fixed downlink resources, it is possible to flexibly use the other resources. As dynamic resources except the fixed downlink resources, for example, it is possible to flexibly allocate to downlink or uplink corresponding to traffic and the like.

In addition, in future radio communication systems, it is expected to actualize various radio communication services so as to meet respective different requirements (e.g., ultra-high speed, high capacity, ultra-low delay, etc.). For example, in the future radio communication system, it is studied to perform communication using beam forming (BF) as described above.

BF is classified into digital BF and analog BF. The digital BF is a method of performing precoding signal processing (on a digital signal) on baseband. In this case, parallel processing of Inverse Fast Fourier Transform (IFFT)/Digital to Analog Converter (DAC)/RF (Radio Frequency) is required corresponding to the number of antenna ports (RF chains). On the other hand, at any timing, it is possible to form the number of beams corresponding to the number of RF chains.

The analog BF is a method using a phase shift device on RF. In this case, since the phase of an RF signal is only rotated, the configuration is easy and is capable of being actualized at low cost, but it is not possible to form a plurality of beams at the same timing. Specifically, in the analog BF, only one beam is formed at a time for each phase shift device.

Therefore, when a radio base station (e.g., called eNB (evolved Node B), Base Station (BS), gNB, etc.) has only one phase shift device, only one beam is capable of being formed at a certain time. Accordingly, in the case of transmitting a plurality of beams using only the analog BF, since it is not possible to transmit concurrently in the same time resource, it is necessary to switch or rotate the beam temporally.

In addition, it is also possible to make a hybrid BF configuration with the digital BF and analog BF combined. In the future radio communication system (e.g., 5G), it is studied to introduce massive MIMO, but when beam forming with the enormous number of beams is performed only by the digital BF, the circuit configuration is expensive. Therefore, in 5G, it is expected to use the analog BF configuration or hybrid BF configuration.

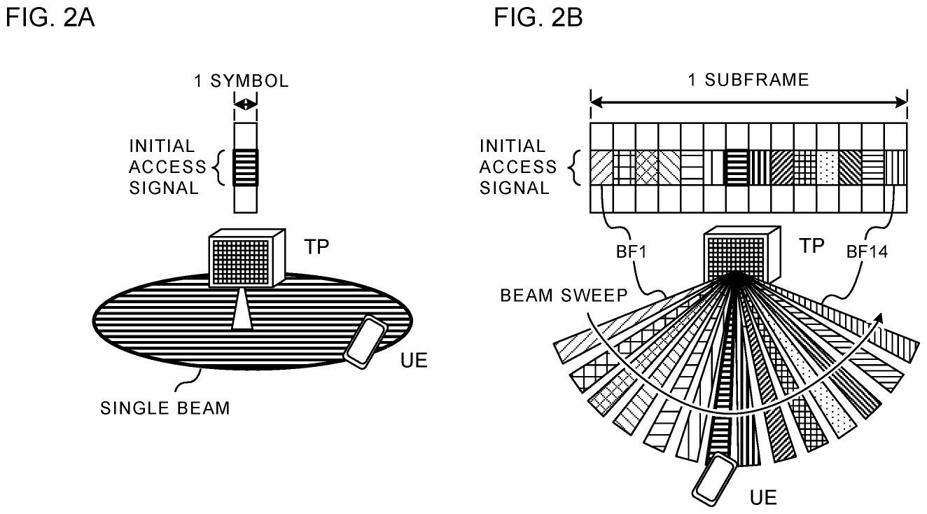

As BF operation, there are single BF operation using one BF, and multiple BF operation using a plurality of kinds of BF. FIG. 2A shows one example of single BF operation, and FIG. 2B shows one example of multiple BF operation. In a cell using single BF operation, an initial access signal is transmitted with a single beam pattern (e.g. non-directivity), and the area is formed.

In a cell using multiple BF operation, an initial access signal is transmitted using a plurality of beam patterns, and the area is formed. For example, in multiple BF operation, it is considered that the signal is transmitted a plurality of times, while applying different beam patterns in the time domain, to enable UE distributing in a wide range to detect the cell (beam sweep). In the case of multiple BF operation, since different beam patterns are applied in the time domain, more initial access signal resources (e.g. synchronization signal, PBCH, etc.) are required in time regions.

In the NR carrier (cell), it is agreed to support both cases of single-beam operation and multi-beam operation. On the initial access signal, it is expected to apply beam sweeping processing for performing transmission repeatedly, while changing the beam, at the time of multi-beam operation. At the time of initial access to an NR carrier (cell), a terminal does not know whether the NR carrier (cell) performs single-beam operation or multi-beam operation, and therefore, it is desirable to enable the terminal to perform detection of at least the synchronization signal, PBCH and the like by common frame work procedure. In the analog BF, since the beam pattern is switched temporally, transmission signals with different beams applied are mapped to different time resources. At the time of detecting the synchronization signal, the user terminal only recognizes timing thereof and ID.

In the NR carrier (cell), it is necessary to determine a procedure of how to receive PBCH after the terminal detects the synchronization signal. In LTE, after primarily detecting symbol timing with PSS, by performing blind detection on a position and sequence of SSS, the terminal recognizes the cell ID, CP length, subframe number, and Duplex mode, and identifies subframe timing from the subframe number. By this means, the terminal is capable of detecting CRS disposed in a known position from the subframe beginning, further performs channel estimation based on the CRS, and is capable of demodulating PBCH disposed in a known position inside the subframe.

As the relative positions of PSS and SSS, there are four patterns corresponding to the CP length and TDD/FDD. Further, when SSS is capable of being detected, the terminal is able to recognize the resource position of PBCH. On the other hand, in the NR carrier (cell), as requirements for resource mapping of synchronization signal and PBCH, as in LTE, the following respect is considered. In other words, in RS to acquire symbol timing, it is desirable that the number of sequence patterns is low. This is because the load is increased by performing time correlation processing to detect timing on many patterns. Further, RS to detect the cell ID requires the sufficient number of sequence patterns. Accordingly, it is also considered that at least two signals are defined including PSS with the low number of patterns mainly used in timing detection, and SSS with the high number of patterns mainly used in ID detection. It is desirable that the relative resource positions of PSS and SSS have the low number of patterns, and that the relative resource positions of synchronization signal (PSS/SSS) and PBCH are fixed. In addition, such a possibility is high that PBCH is not capable of sending all information required for initial access. In this case, schemes are required such as SIB transmission on PDSCH.

Further, in the case of using two kinds of signals (e.g., PSS and SSS) as the synchronization signal, the TDM scheme and FDM scheme are considered in the arrangement of relative resource positions of PSS and SSS.

(TDM scheme)

For example, it is considered that the synchronization signal is mapped to different symbols inside the same subframe (or slot) (the same method as in LTE). In multi-beam operation, it is expected to transmit PSS and SSS, while changing the beam pattern, and particularly, in order to enable operation also in analog BF, it is necessary to change the beam pattern every two symbols of PSS and SSS (not to change the beam pattern in two symbols).

However, the number of symbols is 2N required to finish changing N beam patterns once. Assuming that the number of symbols in a subframe (or slot) is certain, there are demerits that the number of beam patterns capable of being supported therein is limited, and that transmission resource mapping of the initial access signal is complicated. Further, in the case of supporting different CP lengths, in TDM, the spacing of effective symbols is separate corresponding to the CP length, and therefore, when the CP length is varied, the spacing is also varied. As a result, candidates for the position of SSS are increased, and there is the demerit that blind detection is necessary.

### (Fdm Scheme)

For example, on the same symbol, it is considered that PSS and SSS are mapped to different frequency resources. As distinct from the above-mentioned TDM scheme, since it is possible to transmit both PSS and SSS in one symbol, the number of symbols is N required to finish changing N beam patterns once. Assuming that the number of symbols in a subframe (or slot) is certain, the number of beam patterns capable of being supported therein is twice that in the above-mentioned TDM scheme. Since PSS and SSS are on the same symbol, the terminal is capable of detecting the SSS, even without knowing the CP length.

However, the terminal needs to monitor a wide band including both PSS and SSS at the time of initial access. Therefore, there is a possibility that the load and power consumption of the terminal in initial access is increased more than in the above-mentioned TDM scheme.

Further, the TDM scheme and FDM scheme are considered in the arrangement of relative resource positions of synchronization signal and PBCH.

### (TDM Scheme)

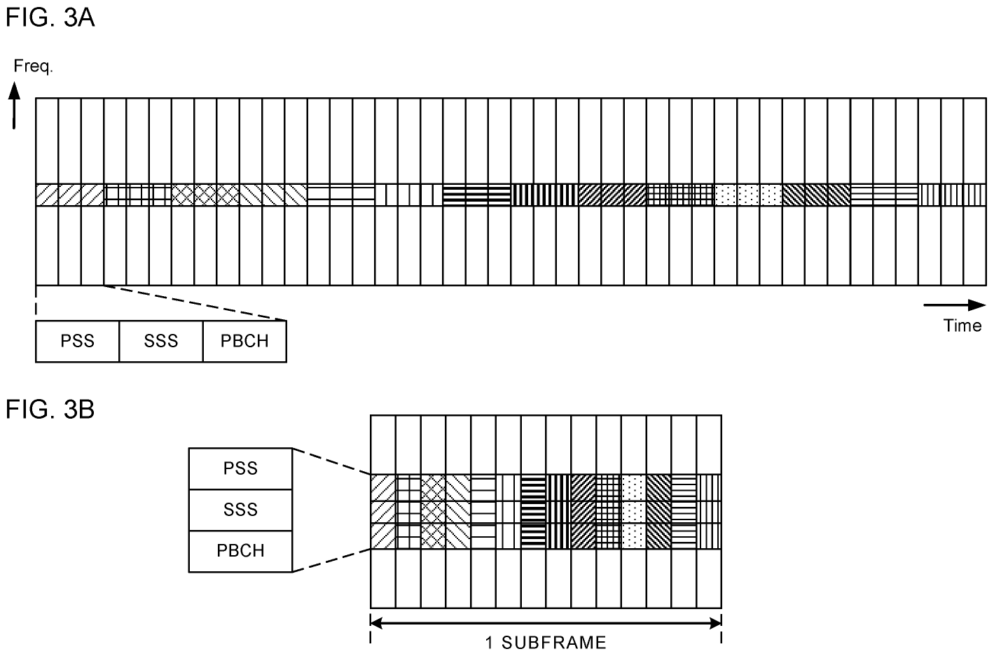

For example, as in LTE, it is considered that the synchronization signal and PBCH are mapped to different symbols inside the same subframe. FIG. 3A shows an example where PSS, SSS and PBCH are mapped to three contiguous symbols. Since the beam is switched in a whole of three symbols, at the time of initial access, the terminal receives the PSS, SSS and PBCH in a whole of three symbols.

However, as in the TDM scheme of the above-mentioned synchronization signal, the number of symbols required to switch beam patterns once is increased. Further, in the case of supporting different CP lengths, blind detection is required to determine the CP length with respect to the SSS. Further, as in LTE, in the case where the PBCH is mapped astride a plurality of contiguous symbols, there is the demerit that more symbols are required for each beam pattern.

### (Fdm Scheme)

For example, it is considered that the synchronization signal and PBCH are mapped to different frequency resources of the same symbol. FIG. 3B shows an example where PSS, SSS and PBCH are mapped contiguously to frequency regions on the same symbol. In this case, at the time of initial access, the terminal needs to receive the PSS, SSS and PBCH in a wide range in the frequency region.

However, as in the FDM scheme of the above-mentioned synchronization signal, the number of symbols required to switch beam patterns once is suppressed, but since the monitor bandwidth is widened, there is a possibility that the load on the terminal is increased.

Therefore, the inventors of the present invention noted that TDM is effective to avoid increases in load on the terminal due to increases in monitor band, and that inter-resource of the same symbol number in different subframes (or slots) is not dependent on the CP length and is certain in time interval, and conceived mapping a synchronization signal and broadcast channel with the same beam (beam pattern) applied to the same time region (e.g., symbol) in different transmission time intervals (e.g., subframes, slots, etc.) to control transmission and reception.

For example, in one aspect of this Embodiment, a user terminal controls reception processing, while assuming that a synchronization signal and broadcast channel with the same beam (beam pattern) applied are allocated to the same time region in different transmission time intervals. By this means, the synchronization signal (PSS/SSS) and broadcast channel (PBCH, etc.) are made TDM, and it is thereby possible to suppress increases in load due to increases in monitor band of the user terminal. Further, since inter-resource of the same time region (e.g., same symbol number) in different transmission time intervals (e.g., subframes or slots) is not dependent on the CP length and is certain in time interval, a time resource position of the broadcast channel is determined from a time resource position of the detected synchronization signal, without the user terminal knowing the CP length and the symbol number of the detected synchronization signal, and the terminal does thereby not need blind detection of the CP length and symbol number.

In another aspect of this Embodiment, a user terminal performs reception processing, while assuming that symbol index information and CP length information in a transmission time interval (e.g., subframe or slot) is transmitted on a broadcast channel (e.g., PBCH, SIB). Alternatively, a user terminal performs reception processing on the CP length information inside the SIB, while assuming that a resource of common search space for scheduling the SIB and the like, or SIB resource is a resource on the same symbol of the same transmission time interval (subframe, slot or the like) or of the same symbol number inside different transmission time intervals (subframes, slots or the like). By this means, in the case of supporting different CP lengths in the NR carrier, the need of blind detection of the CP length is eliminated.

Embodiments according to the present invention will be described below in detail with reference to drawings. A radio communication method according to each Embodiment may be applied alone, or may be applied in combination.

In addition, in the present Description, for example, “a plurality of beams (beam patterns) differs” is assumed to represent the case where at least one differs among the following (1) to (6) respectively applied to a plurality of beams, but is not limited thereto. (1) Precoding, (2) transmit power, (3) phase rotation, (4) beam width, (5) angle of a beam (e.g., tilt angle) and (6) the number of layers. In addition, in the case where precoding differs, precoding weights may differ, or schemes (e.g., linear precoding and nonlinear precoding) of precoding may differ. In the case of applying linear/nonlinear precoding to beams, transmit power, phase rotation, the number of layers also may vary.

As an example of linear precoding, there is precoding in conformity with Zero-Forcing (ZF) standards, Regularized Zero-Forcing (R-ZF) standards, Minimum Mean Square Error (MMSE) standards or the like, Further, as an example nonlinear precoding, there is precoding of Dirty Paper Coding (DPC), Vector Perturbation (VP), Tomlinson Harashima Precoding (THP) and the like. In addition, the applied precoding is not limited thereto.

### Embodiment 1

Embodiment 1 describes the aspect where a user terminal performs reception processing, while assuming that a synchronization signal and broadcast channel with the same beam (beam pattern) applied are allocated to the same time region in different transmission time intervals. In the following description, as the transmission time interval, a subframe or slot will be exemplified, but another time unit may be used. In addition, in the following description, the case will be shown and described where the synchronization signal is comprised of a first synchronization signal (PSS) and a second synchronization signal (SSS), but the configuration (number, type, etc.) of the synchronization signal is not limited thereto.

### <Aspect 1>

In Aspect 1, the first synchronization signal and second synchronization signal are subjected to FDM (Frequency Division Multiplexing) on the same symbol. The description will be made on the assumption that the first synchronization signal is PSS, and that the second synchronization signal is SSS, and PBCH is exemplified as the broadcast channel.

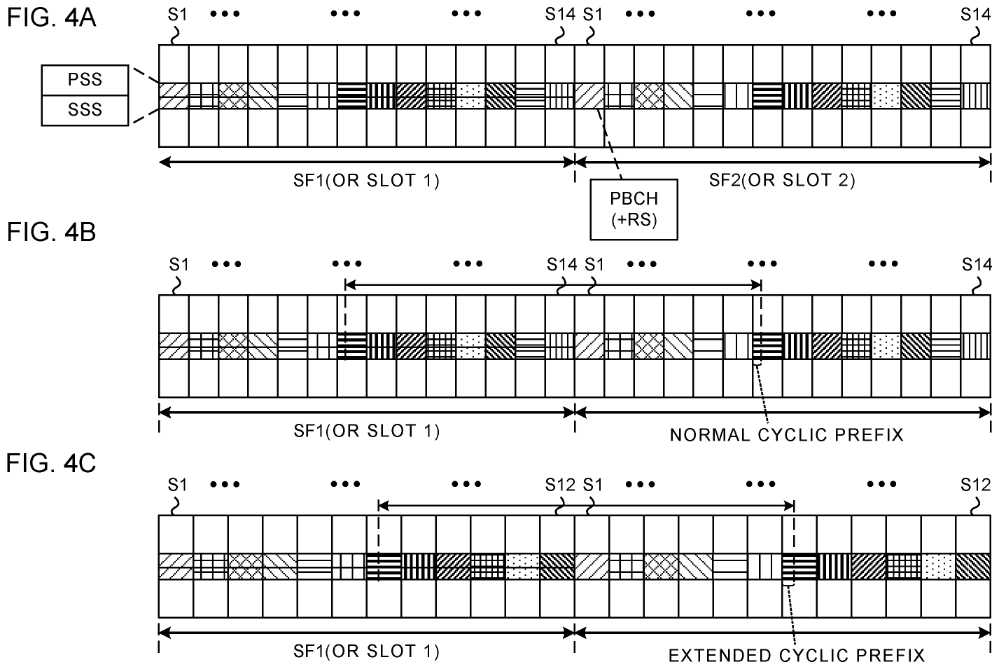

FIG. 4A illustrates resource allocation of PSS/SSS and PBCH based on Aspect 1. FIG. 4A shows two subframes (SF1, SF2) among a plurality of subframes constituting a radio frame, and illustrates the case where one subframe is comprised of the predetermined number of time regions (e.g., 14 OFDM symbols). In different subframes SF1, SF2, the same beam (beam pattern) is applied to the same symbol number (S1 to S14).

Specifically, in each subframe, beam transmission is executed 14 times, while applying different beam patterns in the time domain inside one subframe. As shown in FIG. 4A, in the first subframe SF1, PSS/SSS with one of different beam patterns BF1 to BF14 applied is mapped to each symbol (S1 to S14). In the latter subframe SF2, PBCH with the same one of beam patterns BF1 to BF14 as in the first subframe SF1 applied is mapped to each symbol (S1 to S14).

Each user terminal receives the PSS/SSS and PBCH with a predetermined beam applied (mapped to a predetermined symbol) corresponding to a position and the like of the user terminal. For example, when some user terminal detects the PSS/SSS in a predetermined time region (e.g., S1), the terminal performs reception processing, while assuming that the PBCH is mapped to the same time region (S1) in a different subframe.

In Aspect 1, the PSS and SSS are subjected to FDM on the same symbol. The PBCH is mapped to the time resource of the same symbol number as that of the PSS/SSS in the subframe SF2 (or slot) different from that of the PSS/SSS.

At this point, as shown in FIG. 4A, the PBCH may be in the same bandwidth as the total bandwidth in performing FDM on the PSS/SSS. By this means, it is possible to make monitor bandwidths of the synchronization signal and broadcast channel certain at the time of initial access of the user terminal.

In Aspect 1, by applying FDM on PBCH and RS for PBCH demodulation, the RS for PBCH demodulation may be mapped to the same time resource as that of the PBCH. Since the PBCH resource is separated from the PSS/SSS corresponding to one subframe (or one slot), by using another RS in PBCH demodulation, it is possible to increase demodulation accuracy of the PBCH. Further, by performing FDM on PBCH and RS of PBCH demodulation, it is possible to minimize the number of transmission symbols per beam pattern.

In Aspect 1, one OFDM symbol is allocated to the PBCH (+RS) transmitted in one transmission beam (also called TRP (Transmission Reception Point) TX beam). In the present Description, the state where the RS for PBCH demodulation undergoes FDM with the PBCH on the same symbol is expressed as “PBCH (+RS)”. When one symbol is allocated to a beam pattern for transmitting PSS and SSS subjected to FDM, by allocating one symbol also to the beam pattern for transmitting the PBCH and RS for PBCH demodulation subjected to FDM, it is possible to map to the same symbol number in a different subframe (or slot).

Referring to FIGS. 4B and 4C, it will be described that the time intervals of PSS/SSS and PBCH mapped to different subframes are certain without being dependent on the CP length. In the subframe configuration shown in FIG. 4B, Normal CP is applied, and 1 subframe is comprised of 14 OFDM symbols. On the other hand, in the subframe configuration shown in FIG. 4C, extended CP is applied, and 1 subframe is comprised of 12 OFDM symbols.

In the example shown in FIG. 4B, based on Aspect 1, PSS/SSS is mapped to the symbol number S7 of the first subframe SF1, and PBCH (+RS) is mapped to the symbol number S7 of the latter subframe SF2. The time interval between PSS/SSS and PBCH in resource allocation with Normal CP applied is fixed time T. On the other hand, in the example shown in FIG. 4C, based on Aspect 1, PSS/SSS is mapped to the symbol number S7 of the first subframe SF1, and PBCH (+RS) is mapped to the symbol number S7 of the latter subframe SF2. It is understood that the time interval between PSS/SSS and PBCH in resource allocation with extended CP applied is the same fixed time T as in the case of applying extended CP.

Thus, the time resource interval between PSS/SSS and PBCH is fixed, and it is thereby possible to recognize up to the PBCH, without knowing the symbol number or the CP length. Further, it is possible to suppress the number of symbols required to finish changing beams of N patterns once in beam sweeping to make the number N, and it is possible to actualize beam sweeping closed inside the time of a subframe (or slot).

In addition, the PBCH may have a bandwidth different from the total bandwidth in performing FDM on PSS and SSS. For example, it is possible to set the PBCH for a bandwidth more than that of PSS/SSS. In this case, a user terminal widens the monitor bandwidth after detecting the synchronization signal to execute reception processing for detecting the PBCH. By this means, since it is possible to extend the transmission bandwidth of PBCH, it is possible to send more information on the PBCH. Further, by decreasing coding rate and/or the M-ary modulation level of information sent on the PBCH, it is possible to enhance reliability of the information.

Further, different transmission bandwidths (sequence lengths) may be applied between PSS and SSS. Since the SSS requires the high number of sequences and low mutual correlation between sequences, by extending the transmission bandwidth (sequence length) of SSS to be wider than the transmission bandwidth of PSS (or make the sequence length longer), it is possible to perform flexible operation in accordance with characteristics of PSS and SSS.

### <Aspect 2>

In Aspect 2, the first synchronization signal and second synchronization signals are subjected to TDM (Time Division Multiplexing) on contiguous symbols. The description will be made on the assumption that the first synchronization signal is PSS, and that the second synchronization signal is SSS, and PBCH is exemplified as the broadcast channel.

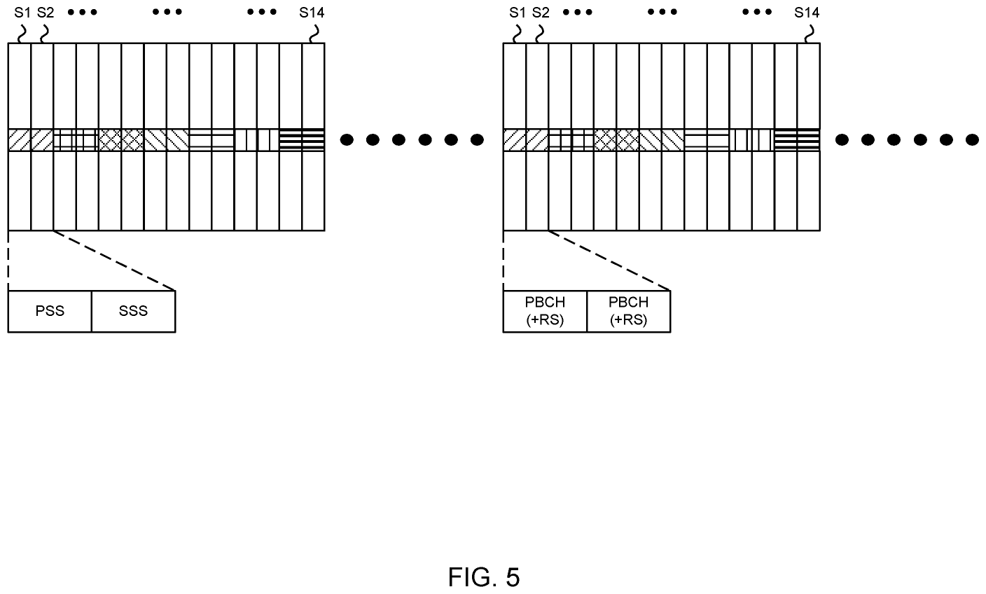

FIG. 5 illustrates resource allocation of PSS/SSS and PBCH based on Aspect 2. In Aspect 2, the PSS and SSS are subjected to TDM on contiguous symbols. The PBCH is mapped to time regions of the same symbol numbers as two symbol numbers of the PSS and SSS, respectively, in a subframe SF2 (or slot) different from that of the PSS/SSS.

As shown in FIG. 5, since two symbols per beam pattern are used in the PSS and SSS, two symbols per beam pattern are used also in the PBCH (+RS). By this means, it is possible to secure a wider region in the transmission bandwidth (sequence length) of each of the PSS and SSS, as compared with the case of performing FDM on the PSS and SSS as in Aspect 1, and it is possible to improve detection characteristics. In addition, since the time resource interval of PSS and SSS varies with the CP length, it is necessary to perform blind detection of the CP length at the time of SSS detection.

In Aspect 2, as shown in FIG. 5, the transmission bandwidths of PSS, SSS and PBCH are configured to be the same. By this means, it is possible to make monitor bandwidths of a terminal for initial access processing certain. Further, by applying FDM, RS for PBCH demodulation and PBCH are mapped to the same symbol. In Aspect 2, since two symbols are used for one beam pattern in PSS and SSS, it is possible to use two symbols also for PBCH and RS for PBCH demodulation subjected to FDM. By this means, it is possible to increase an information amount sent on the PBCH, and to enhance reliability.

In addition, in resource allocation shown in FIG. 5, the transmission bandwidths of PSS, SSS and PBCH are configured to be the same, but are not limited thereto. For example, with respect to transmission bandwidths of PSS and SSS, transmission bandwidths of PSS and PBCH, and transmission bandwidths of SSS and PBCH, any one of the transmission bandwidths may be wider. In this case, a user terminal widens the monitor bandwidth after detecting the PSS or SSS, and receives the SSS or PBCH with the transmission bandwidth wider than in the PSS or SSS. By this means, it is possible to send more information on the PBCH, further it is possible to decrease the coding rate and the M-ary modulation level, and it is thereby possible to enhance reliability.

Further, in resource allocation shown in FIG. 5, PBCH and RS for PBCH demodulation are subjected to FDM in a frequency region on one symbol, but are not limited thereto. For example, PBCH and RS for PBCH demodulation may be mapped by TDM. For example, PBCH and RS for PBCH demodulation of some transmission beam may be separated onto two OFDM symbols to map.

### <Aspect 3>

In Aspect 3, the first synchronization signal and second synchronization signal are subjected to TDM on resources of the same symbol number in different subframes (or slots). The description will be made on the assumption that the first synchronization signal is PSS, and that the second synchronization signal is SSS, and PBCH is exemplified as the broadcast channel.

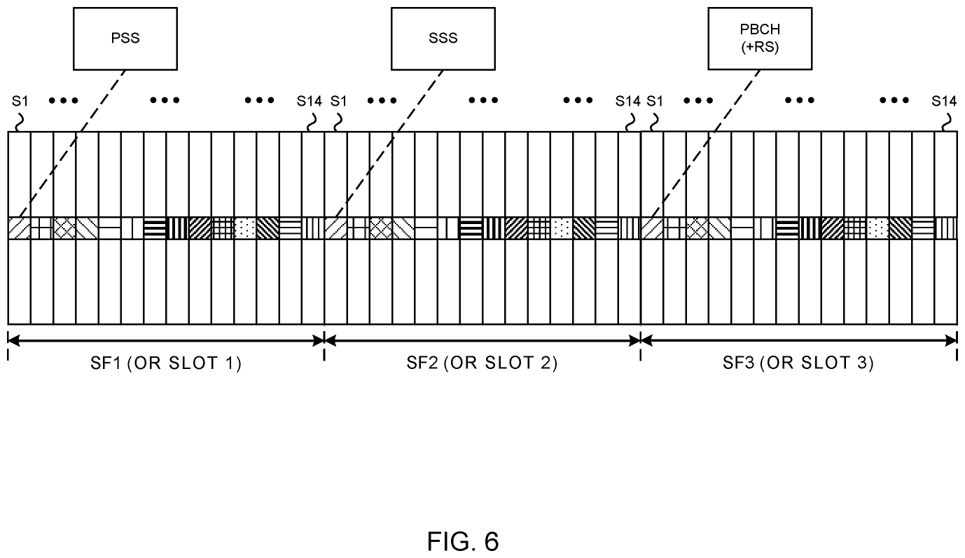

FIG. 6 illustrates resource allocation of PSS, SSS and PBCH based on Aspect 3. In Aspect 3, the PSS and SSS with the same beam pattern applied are subjected to TDM on resources of the same symbol number S1 in different subframes (or slots) SF1, SF2. The PBCH is mapped to a time region of the same symbol number S1 as the symbol number of PSS/SSS, in a subframe SF3 (or slot) different from PSS/SSS.

Each user terminal receives the PSS, SSS and PBCH with a predetermined beam applied (mapped to a predetermined symbol) corresponding to a position and the like of the user terminal. For example, when some user terminal detects the PSS in a predetermined time region (e.g., S1), the terminal performs reception processing, while assuming that the SSS and PBCH are mapped to the same time region (S1) in different subframes, respectively.

At this point, as shown in FIG. 6, the PSS, SSS and PBCH may have the same bandwidth. By this means, it is possible to make monitor bandwidths of the synchronization signal and broadcast channel certain at the time of initial access of the user terminal. Further, since the PSS and SSS are not subjected to FDM in the frequency region on one symbol, it is possible to widen the transmission bandwidth (sequence length) of each of the PSS and SSS, and it is possible to improve detection characteristics.

Further, since the resource to which the PBCH is mapped is separated from the PSS or SSS in the time-axis direction corresponding to one subframe (or one slot) or more, by using another RS for PBCH demodulation, it is possible to enhance demodulation accuracy of the PBCH. Further, as shown in FIG. 6, by performing FDM on PBCH and RS for PBCH demodulation, it is possible to minimize the number of transmission symbols per beam pattern.

Furthermore, in Aspect 3, as shown in FIG. 6, the PBCH transmitted in one transmission beam is mapped to one OFDM symbol to match with the number of transmission symbols of each beam pattern for transmitting the PSS and SSS. When the number of transmission symbols of a beam pattern for transmitting PSS/SSS is made “1”, the number of transmission symbols of a beam pattern for transmitting PBCH (+RS) needs to be “1” to enable mapping to the same symbol number in a different subframe (or slot), and according to Aspect 3, it is possible to avoid such inconvenience.

In addition, in resource allocation shown in FIG. 6, the transmission bandwidths of PSS, SSS and PBCH are configured to be the same, but are not limited thereto. For example, in transmission bandwidths of PSS and SSS, transmission bandwidths of PSS and PBCH, and transmission bandwidths of SSS and PBCH, any one of the transmission bandwidths may differ. In this case, a user terminal widens the monitor bandwidth after detecting the PSS or SSS, and receives the SSS or PBCH with the bandwidth wider than in the PSS or SSS. By this means, it is possible to send more information on the PBCH, further it is possible to decrease the coding rate and the M-ary modulation level, and it is thereby possible to enhance reliability. Further, since the time resource intervals are fixed among the PSS, SSS and PBCH, it is possible to also recognize up to the PBCH, without knowing the symbol number or the CP length.

### <Modification>

In single-beam operation or multi-beam operation with the low number of beam patterns, PSS/SSS and PBCH may be mapped from predetermined (for example, last) OFDM symbols in respective subframes (or slots).

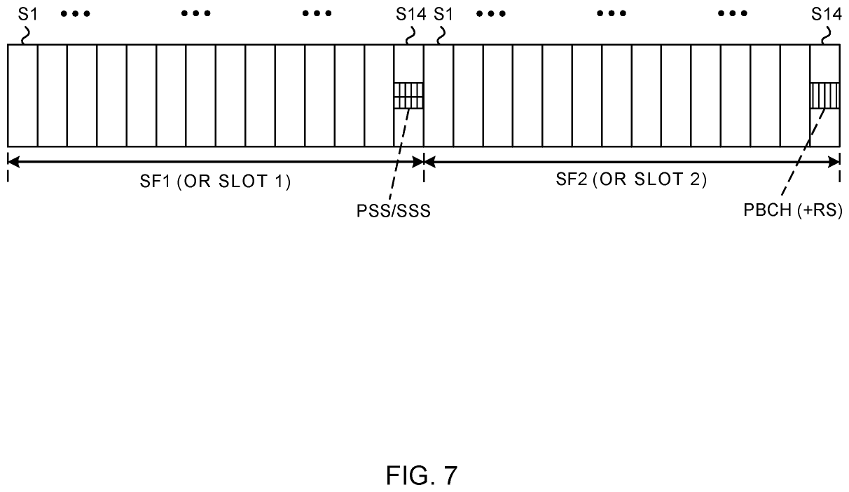

FIG. 7 illustrates resource allocation where PSS/SSS and PBCH are mapped from last OFDM symbols in different subframes (or slots). The PSS/SSS is mapped to the last OFDM symbol S14 in a first subframe SF1, and the PBCH is mapped to the last OFDM symbol S14 in a latter subframe SF2.

Thus, by mapping PSS/SSS and PBCH from predetermined (for example, last) OFDM symbols in different subframes (or slots), since relative resource positions of PSS/SSS and PBCH are fixed, a user terminal is capable of detecting the PBCH, even without knowing the number of beams or CP length. Further, in each subframe (or slot), it is possible to use the other OFDM symbols in data transmission and the like.

In the case of using OFDM symbols except OFDM symbols including PSS, SSS and PBCH in data transmission and the like, it may be made possible to apply rate matching to the OFDM symbols including PSS, SSS and PBCH. For example, the radio base station notifies a user terminal of information on the number of applied beams, using system information and the like. Alternatively, the radio base station may notify of the number of symbols with rate matching applied (or the number of symbols used in data transmission) and/or position via DCI. In the case of beforehand defining that mapping is performed sequentially from a fixed symbol such as the last symbol, when the user terminal is capable of acquiring the information on the number of applied beams from the system information and the like, the terminal is capable of determining the resource to apply rate matching.

As described above, according to Embodiment 1, in both of single-beam and multi-beam, time resource intervals are fixed between PSS and SSS, and between PSS/SSS and PBCH, without knowing the symbol number or the CP length, the user terminal is capable of recognizing up to the PBCH.

### Embodiment 2

In Embodiment 2, symbol index information and CP length information in a subframe (or slot) is transmitted on the PBCH, instead of performing blind detection.

According to the above-mentioned Embodiment 1, the user terminal is capable of recognizing up to the PBCH, without knowing the symbol index and CP length information in subframes (or slots) of PSS/SSS and PBCH. By notifying the user terminal of these pieces of information on the PBCH, the user terminal is capable of recognizing a subframe boundary (or slot boundary), further recognizing a boundary of radio frames when the radio frame number (SFN) is sent, and is capable of reading even when the SIB or the like (common search space) is transmitted in any symbol.

Further, the case is expected where the symbol index information and CP length information is transmitted in SIB, instead of transmitting on PBCH. In this case, it is necessary to recognize the common search space in a state in which a user terminal does not know the symbol index information and CP length information.

Therefore, the user terminal assumes that the resource of the common search space for scheduling the SIB and the like is mapped to resources of the same symbol as that of the broadcast channel (common search space) and/or synchronization signal with the same beam applied, or of the same symbol number in different subframes (or slots). For example, in the case where FDM is applied to the broadcast channel and SIB, the terminal assumes that the common search space is mapped to the same symbol.

By this means, when the user terminal identifies the PBCH from a symbol of some subframe, the terminal detects the presence or absence of SIB in other frequency resources of the same symbol as the PBCH or resources of the same symbol number in different subframes. When the SIB exists, the user terminal interprets the symbol index information and CP length information from resources designated by the SIB.

Thus, without knowing the symbol index information or CP length information, the user terminal is capable of interpreting the SIB. Further, it is possible to send the symbol index information and CP length information in the SIB. Furthermore, the common search space and PDSCH including the SIB may be subjected to FDM. By this means, it is possible to perform beam sweeping, while switching the beam pattern for each symbol. Still furthermore, the user terminal is required to perform wideband processing only in a particular case of needing to interpret the SIB such as at the time of initial access, in the case of receiving SIB change notification and the like.

### (Radio Communication System)

A configuration of a radio communication system according to one Embodiment of the present invention will be described below. In the radio communication system, communication is performed by using any of the above-mentioned Aspects of the invention or combination thereof.

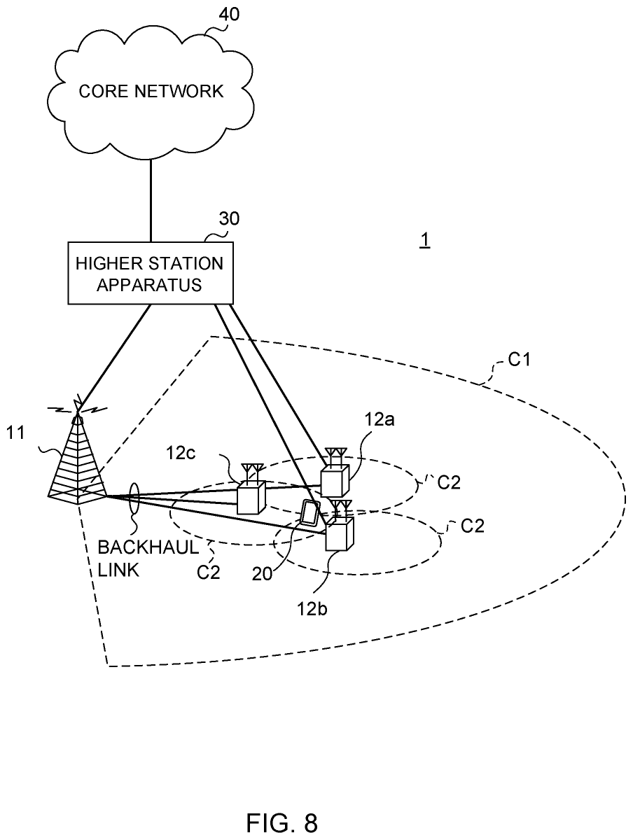

FIG. 8 is a diagram showing one example of a schematic configuration of the radio communication system according to one Embodiment of the present invention. In the radio communication system 1, it is possible to apply carrier aggregation (CA) to aggregate a plurality of base frequency blocks (component carriers) with a system bandwidth (e.g., 20 MHz) of the LTE system as one unit and/or dual connectivity (DC).

In addition, the radio communication system 1 may be called LTE (Long Term Evolution), LTE-A (LTE-Advanced), LTE-B (LTE-Beyond), SUPER 3G, IMT-Advanced, 4G (4th Generation mobile communication system), 5G (5th generation mobile communication system), FRA (Future Radio Access), New-RAT (Radio Access Technology) and the like, or may be called the system to actualize each system described above.

The radio communication system 1 is provided with a radio base station 11 for forming a macrocell C1 with relatively wide coverage, and radio base stations 12 (12a to 12c) disposed inside the macrocell C1 to form small cells C2 narrower than the macrocell C1. Further, a user terminal 20 is disposed in the macrocell C1 and each of the small cells C2.

The user terminal 20 is capable of connecting to both the radio base station 11 and the radio base station 12. The user terminal 20 is assumed to concurrently use the macrocell C1 and small cell C2 using CA or DC. Further, the user terminal 20 may apply CA or DC using a plurality of cells (CCs) (e.g., 5 CCs or less, 6 CCs or more).

The user terminal 20 and radio base station 11 are capable of communicating with each other using carriers (called the existing carrier, Legacy carrier and the like) with a narrow bandwidth in a relatively low frequency band (e.g., 2 GHz). On the other hand, the user terminal 20 and radio base station 12 may use carriers with a wide bandwidth in a relatively high frequency band (e.g., 3.5 GHz, 5 GHz, etc.), or may use the same carrier as in the radio base station 11. In addition, the configuration of the frequency band used in each radio base station is not limited thereto.

It is possible to configure so that the radio base station 11 and radio base station 12 (or, two radio base stations 12) undergo wired connection (e.g., optical fiber in conformity with CPRI (Common Public Radio Interface), X2 interface, etc.), or wireless connection.

The radio base station 11 and each of the radio base stations 12 are respectively connected to a higher station apparatus 30, and are connected to a core network 40 via the higher station apparatus 30. In addition, for example, the higher station apparatus 30 includes an access gateway apparatus, Radio Network Controller (RNC), Mobility Management Entity (MME) and the like, but is not limited thereto. Further, each of the radio base stations 12 may be connected to the higher station apparatus 30 via the radio base station 11.

In addition, the radio base station 11 is a radio base station having relatively wide coverage, and may be called a macro base station, collection node, eNB (eNodeB), transmission and reception point and the like. Further, the radio base station 12 is a radio base station having local coverage, and may be called a small base station, micro-base station, pico-base station, femto-base station, HeNB (Home eNodeB), RRH (Remote Radio Head), transmission and reception point and the like. Hereinafter, in the case of not distinguishing between the radio base stations 11 and 12, the stations are collectively called a radio base station 10.

Each user terminal 20 is a terminal supporting various communication schemes such as LTE and LTE-A, and may include a fixed communication terminal (fixed station), as well as the mobile communication terminal (mobile station).

In the radio communication system 1, as radio access schemes, Orthogonal Frequency Division Multiple Access (OFDMA) is applied on downlink, and Single Carrier Frequency Division Multiple Access (SC-FDMA) is applied on uplink.

OFDMA is a multicarrier transmission scheme for dividing a frequency band into a plurality of narrow frequency bands (subcarriers), and mapping data to each subcarrier to perform communication. SC-FDMA is a single-carrier transmission scheme for dividing a system bandwidth into bands comprised of one or contiguous resource blocks for each terminal so that a plurality of terminals uses mutually different bands, and thereby reducing interference among terminals. In addition, uplink and downlink radio access schemes are not limited to the combination of the schemes, and another radio access scheme may be used.

As downlink channels, in the radio communication system 1 are used a downlink shared channel (PDSCH: Physical Downlink Shared Channel) shared by user terminals 20, broadcast channel (PBCH: Physical Broadcast Channel), downlink L1/L2 control channels and the like. User data, higher layer control information, SIB (System Information Block) and the like are transmitted on the PDSCH. Further, MIB (Master Information Block) is transmitted on the PBCH. A common control channel for notifying of the presence or absence of a paging channel is mapped to the downlink L1/L2 control channel (e.g., PDCCH), and data of the paging channel (PCH) is mapped to the PDSCH. Downlink reference signals, uplink reference signals, and synchronization signals of physical downlink are separately allocated.

The downlink L1/L2 control channel includes PDCCH (Physical Downlink Control Channel), EPDCCH (Enhanced Physical Downlink Control Channel), PCFICH (Physical Control Format Indicator Channel), PHICH (Physical Hybrid-ARQ Indicator Channel) and the like. The downlink control information (DCI) including scheduling information of the PDSCH and PUSCH and the like is transmitted on the PDCCH. The number of OFDM symbols used in the PDCCH is transmitted on the PCFICH. Receipt confirmation information (e.g., also referred to as retransmission control information, HARQ-ACK, ACK/NACK, etc.) of HARQ (Hybrid Automatic Repeat Request) for the PUSCH is transmitted on the PHICH. The EPDCCH is frequency division multiplexed with the PDSCH (downlink shared data channel) to be used in transmitting the DCI and the like as the PDCCH.

As uplink channels, in the radio communication system 1 are used an uplink shared channel (PUSCH: Physical Uplink Shared Channel) shared by user terminals 20, uplink control channel (PUCCH: Physical Uplink Control Channel), random access channel (PRACH: Physical Random Access Channel) and the like. User data and higher layer control information is transmitted on the PUSCH. Further, radio quality information (CQI: Channel Quality Indicator) of downlink, receipt confirmation information and the like are transmitted on the PUCCH. A random access preamble to establish connection with the cell is transmitted on the PRACH.

As downlink reference signals, in the radio communication system 1 are transmitted Cell-specific Reference Signal (CRS), Channel State Information Reference Signal (CSI-RS), Demodulation Reference Signal (DMRS), Positioning Reference Signal (PRS) and the like. Further, as uplink reference signals, in the radio communication system 1 are transmitted Sounding Reference Signal (SRS), Demodulation Reference Signal (DMRS) and the like. In addition, the DMRS may be called UE-specific Reference Signal. Further, the transmitted reference signals are not limited thereto.

### (Radio Base Station)

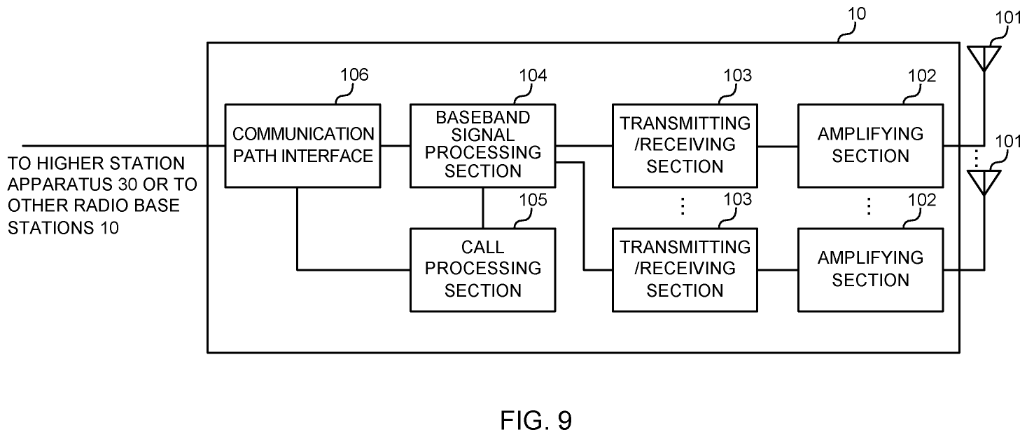

FIG. 9 is a diagram showing one example of an entire configuration of the radio base station according to one Embodiment of the present invention. The radio base station 10 is provided with a plurality of transmitting/receiving antennas 101, amplifying sections 102, transmitting/receiving sections 103, baseband signal processing section 104, call processing section 105, and communication path interface 106. In addition, with respect to each of the transmitting/receiving antenna 101, amplifying section 102, and transmitting/receiving section 103, the radio base station may be configured to include at least one or more.

User data to transmit to the user terminal 20 from the radio base station 10 on downlink is input to the baseband signal processing section 104 from the higher station apparatus 30 via the communication path interface 106.

The baseband signal processing section 104 performs, on the user data, transmission processing such as processing of PDCP (Packet Data Convergence Protocol) layer, segmentation and concatenation of the user data, transmission processing of RLC (Radio Link Control) layer such as RLC retransmission control, MAC (Medium Access Control) retransmission control (e.g., transmission processing of HARQ), scheduling, transmission format selection, channel coding, Inverse Fast Fourier Transform (IFFT) processing, and precoding processing to transfer to the transmitting/receiving sections 103. Further, also concerning a downlink control signal, the section 104 performs transmission processing such as channel coding and Inverse Fast Fourier Transform on the signal to transfer to the transmitting/receiving sections 103.

Each of the transmitting/receiving sections 103 converts the baseband signal, which is subjected to precoding for each antenna and is output from the baseband signal processing section 104, into a signal with a radio frequency band to transmit. The radio-frequency signal subjected to frequency conversion in the transmitting/receiving section 103 is amplified in the amplifying section 102, and is transmitted from the transmitting/receiving antenna 101. The transmitting/receiving section 103 is capable of being comprised of a transmitter/receiver, transmitting/receiving circuit or transmitting/receiving apparatus explained based on common recognition in the technical field according to the present invention. In addition, the transmitting/receiving section 103 may be comprised as an integrated transmitting/receiving section, or may be comprised of a transmitting section and receiving section.

On the other hand, for uplink signals, radio-frequency signals received in the transmitting/receiving antennas 101 are amplified in the amplifying sections 102. The transmitting/receiving section 103 receives the uplink signal amplified in the amplifying section 102. The transmitting/receiving section 103 performs frequency conversion on the received signal into a baseband signal to output to the baseband signal processing section 104.

For user data included in the input uplink signal, the baseband signal processing section 104 performs Fast Fourier Transform (FFT) processing, Inverse Discrete Fourier Transform (IDFT: INveRSe Discrete Fourier Transform) processing, error correcting decoding, reception processing of MAC retransmission control, and reception processing of RLC layer and PDCP layer to transfer to the higher station apparatus 30 via the communication path interface 106. The call processing section 105 performs call processing such as configuration and release of a communication channel, state management of the radio base station 10, and management of radio resources.

The communication path interface 106 transmits and receives signals to/from the higher station apparatus 30 via a predetermined interface. Further, the communication path interface 106 may transmit and receive signals (backhaul signaling) to/from another radio base station 10 via an inter-base station interface (e.g., optical fiber in conformity with CPRI (Common Public Radio Interface), X2 interface).

In addition, the transmitting/receiving section 103 is provided with an analog beam forming section which is configured to be able to apply both multi-beam approach and single-beam approach and provides analog beam forming. In the case of transmitting the synchronization signal and/or paging channel by multi-beam approach, beam sweeping for sweeping the beam is applied with one or a plurality of contiguous symbols as one unit. The beam forming section is capable of being comprised of a beam forming circuit (e.g., phase shifter, phase shift circuit) or beam forming apparatus (e.g., phase shift device) explained based on the common recognition in the technical field according to the present invention. Further, for example, the transmitting/receiving antenna 101 is capable of being comprised of an array antenna.

The transmitting/receiving section 103 transmits the synchronization signal, broadcast channel, system information (SIB) and the like.

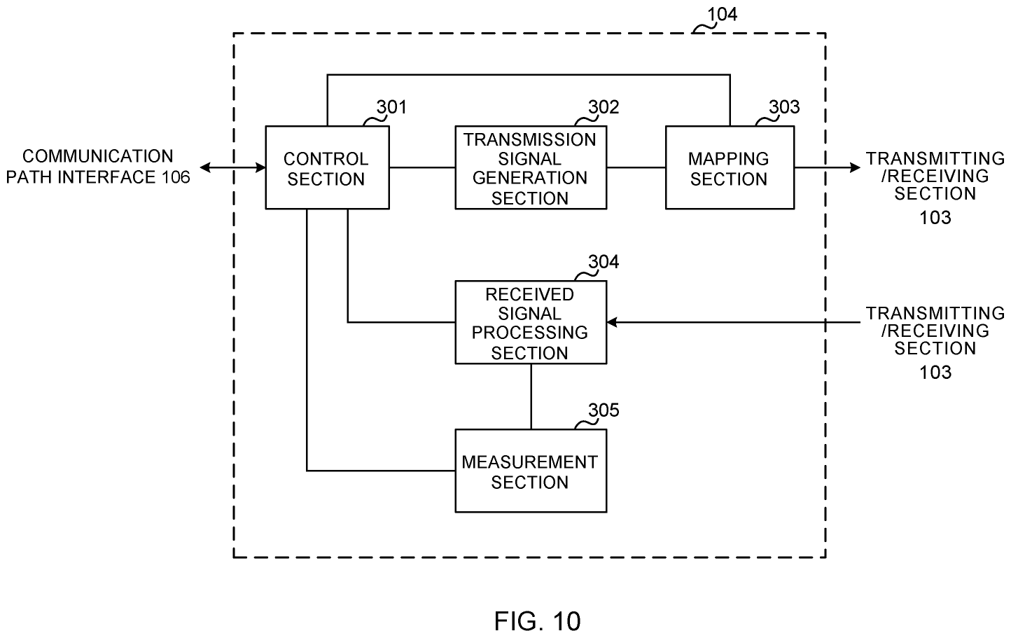

FIG. 10 is a diagram showing one example of a function configuration of the radio base station according to one Embodiment of the present invention. In addition, this example mainly illustrates function blocks of a characteristic portion in this Embodiment, and the radio base station 10 is assumed to have other function blocks required for radio communication.

The baseband signal processing section 104 is provided with at least a control section (scheduler) 301, transmission signal generating section 302, mapping section 303, received signal processing section 304, and measurement section 305. In addition, these components are essentially included in the radio base station 10, and a part or the whole of the components may not be included in the baseband signal processing section 104. The baseband signal processing section 104 is provided with a digital beam forming function for providing digital beam forming.

The control section (scheduler) 301 performs control of the entire radio base station 10. The control section 301 is capable of being comprised of a controller, control circuit or control apparatus explained based on the common recognition in the technical field according to the present invention.

For example, the control section 301 controls generation of signals (including the synchronization signal, and signals that correspond to the MIB, paging channel and broadcast channel) by the transmission signal generating section 302, and allocation of signals by the mapping section 303. The control section 301 controls allocation resources (symbols, frequency resources) to the paging channel tied to resources (symbols, frequency resources) allocated to the synchronization signal and/or MIB described in above-mentioned Aspects 1 to 7. Further, the control section 301 controls reception processing of signals by the received signal processing section 304, and measurement of signals by the measurement section 305.

The control section 301 controls scheduling (e.g., resource allocation, common control channel for notifying of the presence or absence of paging massage, signal for notifying of multi-beam approach, or single-beam approach) of system information (SIB, MIB, etc.), downlink data signal (including PCH of paging message) transmitted on the PDSCH, and downlink control signal transmitted on the PDCCH and/or EPDCCH. The control section 301 schedules the synchronization signal and/or MIB and broadcast channel, schedules the synchronization signal and broadcast channel according to one of resource allocations or any combination thereof described in Embodiments 1 and 2, and controls resource allocation of each signal. The control section 301 controls scheduling of the synchronization signal (e.g., PSS/SSS), and downlink reference signals such as CRS, CSI-RS and DMRS.

The control section 301 allocates the synchronization signal and broadcast channel to the same symbol number of different subframes (or slots) (Aspect 1).

Further, the control section 301 controls scheduling so that PSS and SSS are subjected to FDM on the same symbol, and controls resource allocation so that the PBCH is mapped to time resources of the same symbol number as that of PSS/SSS in a subframe (or slot) different from PSS/SSS. At this point, the PBCH may have the same bandwidth as the total bandwidth in performing FDM on PSS/SSS.

Furthermore, the control section 301 applies FDM to PBCH and RS for PBCH demodulation, and controls resource allocation so that the RS for PBCH demodulation is mapped to the same time resource as that of the PBCH. In addition, the section may perform resource control so that the PBCH has a bandwidth different from the total bandwidth in performing FDM on PSS and SSS. Furthermore, different transmission bandwidths (sequence lengths) may be applied to PSS and SSS.

Moreover, the control section 301 may control resource allocation so that PSS and SSS undergo TDM on contiguous symbols (Aspect 2). For example, resource allocation is controlled so that PSS and SSS are subjected to TDM on contiguous symbols, and that the PBCH is mapped respectively to time regions of the same symbol numbers as two symbol numbers of the PSS and SSS in a subframe (or slot) different from PSS/SSS. Transmission bandwidths of the PSS, SSS and PBCH may be configured to be the same. The section may control so that RS for PBCH demodulation and PBCH are mapped to the same symbol. Alternatively, the section may perform resource control so that any of transmission bandwidths differ in transmission bandwidths of the PSS and SSS, transmission bandwidths of the PSS and PBCH, and transmission bandwidths of the SSS and PBCH. Further, the section may control so that the RS for PBCH demodulation is mapped in TDM with the PBCH.

Further, the control section 301 may control resource allocation so that PSS and SSS are subjected to TDM on resources of the same symbol number in different subframes (or slots) (Aspect 3). At this point, the PSS, SSS and PBCH may have the same bandwidth. Furthermore, the PBCH transmitted in one transmission beam may be mapped to one OFDM symbol to match with the number of transmission symbols of each beam pattern for transmitting the PSS and SSS. In addition, the section may control so that any of transmission bandwidths differs in transmission bandwidths of the PSS and SSS, transmission bandwidths of the PSS and PBCH, and transmission bandwidths of the SSS and PBCH.

Furthermore, in single-beam operation or multi-beam operation with the low number of beam patterns, the control section 301 may control to map PSS/SSS and PBCH from predetermined (for example, last) OFDM symbols in respective subframes (or slots) (Modification).

Still furthermore, the control section 301 may control so as to transmit symbol index information and CP length information in a subframe (or slot) on the PBCH (Embodiment 2).

Moreover, the control section 301 may control resources of the common search space for scheduling the SIB and the like so that the common search space with the same beam applied is mapped to resources of the same symbol number in a different subframe (or slot).

Further, the control section 301 controls scheduling of the uplink data signal transmitted on the PUSCH, uplink control signal (e.g., receipt confirmation information) transmitted on the PUCCH and/or PUSCH, random access preamble transmitted on the PRACH, uplink reference signal and the like.

The control section 301 controls to form a transmission beam and/or reception beam, using digital beam forming (e.g., precoding) by the baseband signal processing section 104 and/or analog beam forming (e.g., phase rotation) by the transmitting/receiving section 103.

For example, in the case of applying multi-beam approach, the control section 301 may control to transmit, while sweeping by applying different beam forming to each symbol in a subframe (sweep period) including the synchronization signal and/or broadcast channel, and paging channel.

Based on instructions from the control section 301, the transmission signal generating section 302 generates downlink signals (downlink control signal, downlink data signal, downlink reference signal, etc.) to output to the mapping section 303. The transmission signal generating section 302 is capable of being comprised of a signal generator, signal generating circuit or signal generating apparatus explained based on the common recognition in the technical field according to the present invention.

For example, based on instructions from the control section 301, the transmission signal generating section 302 generates DL assignment to notify of assignment information of downlink signals and UL grant to notify of assignment information of uplink signals. Further, the downlink data signal is subjected to coding processing and modulation processing, according to a coding rate, modulation scheme and the like determined based on the channel state information (CSI) from each user terminal 20 and the like. Further, based on instructions from the control section 301, the transmission signal generating section 302 generates a signal to notify of multi-beam approach or single-beam approach in the common control channel including the MIB or system information that corresponds to the MIB.

Based on instructions from the control section 301, the mapping section 303 maps the downlink signal generated in the transmission signal generating section 302 to predetermined radio resources to output to the transmitting/receiving section 103. The mapping section 303 is capable of being comprised of a mapper, mapping circuit or mapping apparatus explained based on the common recognition in the technical field according to the present invention. For example, the section maps the synchronization signal and broadcast channel to the same symbol number in different subframes (Aspect 1).

The received signal processing section 304 performs reception processing (e.g., demapping, demodulation, decoding, etc.) on the received signal input from the transmitting/receiving section 103. Herein, for example, the received signal is the uplink signal (uplink control signal, uplink data signal, uplink reference signal, etc.) transmitted from the user terminal 20. The received signal processing section 304 is capable of being comprised of a signal processor, signal processing circuit or signal processing apparatus explained based on the common recognition in the technical field according to the present invention.

The received signal processing section 304 outputs the information decoded by the reception processing to the control section 301. For example, in the case of receiving the PUCCH including HARQ-ACK, the section 304 outputs the HARQ-ACK to the control section 301. Further, the received signal processing section 304 outputs the received signal and signal subjected to the reception processing to the measurement section 305.

The measurement section 305 performs measurement on the received signal. The measurement section 305 is capable of being comprised of a measurement device, measurement circuit or measurement apparatus explained based on the common recognition in the technical field according to the present invention.

For example, the measurement section 305 may measure received power (e.g. RSRP (Reference Signal Received Power)), received quality (e.g. RSRQ (Reference Signal Received Quality), SINR (Signal to Interference plus Noise Ratio)), channel state and the like of the received signal. The measurement result may be output to the control section 301.

### (User Terminal)

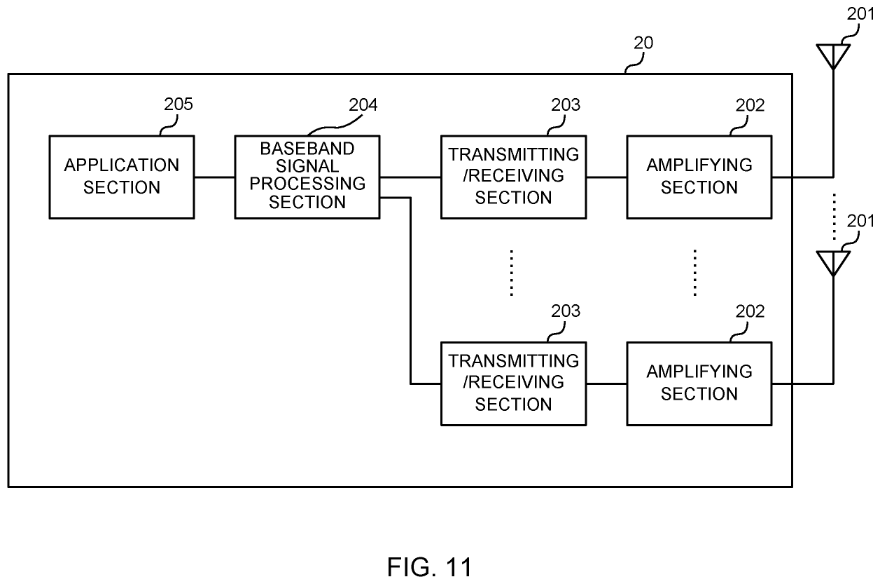

FIG. 11 is a diagram showing one example of an entire configuration of the user terminal according to one Embodiment of the present invention. The user terminal 20 is provided with a plurality of transmitting/receiving antennas 201, amplifying sections 202, transmitting/receiving sections 203, baseband signal processing section 204, and application section 205. In addition, with respect to each of the transmitting/receiving antenna 201, amplifying section 202, and transmitting/receiving section 203, the user terminal may be configured to include at least one or more.

Radio-frequency signals received in the transmitting/receiving antennas 201 are respectively amplified in the amplifying sections 202. Each of the transmitting/receiving sections 203 receives the downlink signal amplified in the amplifying section 202. The transmitting/receiving section 203 performs frequency conversion on the received signal into a baseband signal to output to the baseband signal processing section 204. The transmitting/receiving section 203 is capable of being comprised of a transmitter/receiver, transmitting/receiving circuit or transmitting/receiving apparatus explained based on the common recognition in the technical field according to the present invention. In addition, the transmitting/receiving section 203 may be comprised as an integrated transmitting/receiving section, or may be comprised of a transmitting section and receiving section.

The baseband signal processing section 204 performs FFT processing, error correcting decoding, reception processing of retransmission control and the like on the input baseband signal. User data on downlink is transferred to the application section 205. The application section 205 performs processing concerning layers higher than the physical layer and MAC layer, and the like. Further, among the downlink data, broadcast information is also transferred to the application section 205.

On the other hand, for user data on uplink, the data is input to the baseband signal processing section 204 from the application section 205. The baseband signal processing section 204 performs transmission processing of retransmission control (e.g., transmission processing of HARQ), channel coding, precoding, Discrete Fourier Transform (DFT) processing, IFFT processing and the like to transfer to each of the transmitting/receiving sections 203. Each of the transmitting/receiving sections 203 converts the baseband signal output from the baseband signal processing section 204 into a signal with a radio frequency band to transmit. The radio-frequency signals subjected to frequency conversion in the transmitting/receiving sections 203 are amplified in the amplifying sections 202, and are transmitted from the transmitting/receiving antennas 201, respectively.

In addition, the transmitting/receiving section 203 may further have an analog beam forming section for performing analog beam forming. The analog beam forming section is capable of being comprised of an analog beam forming circuit (e.g., phase shifter, phase shift circuit) or analog beam forming apparatus (e.g., phase shift device) explained based on the common recognition in the technical field according to the present invention. Further, for example, the transmitting/receiving antenna 201 is capable of being comprised of an array antenna.

The transmitting/receiving section 203 receives the synchronization signal, broadcast channel, system information (SIB) and the like.

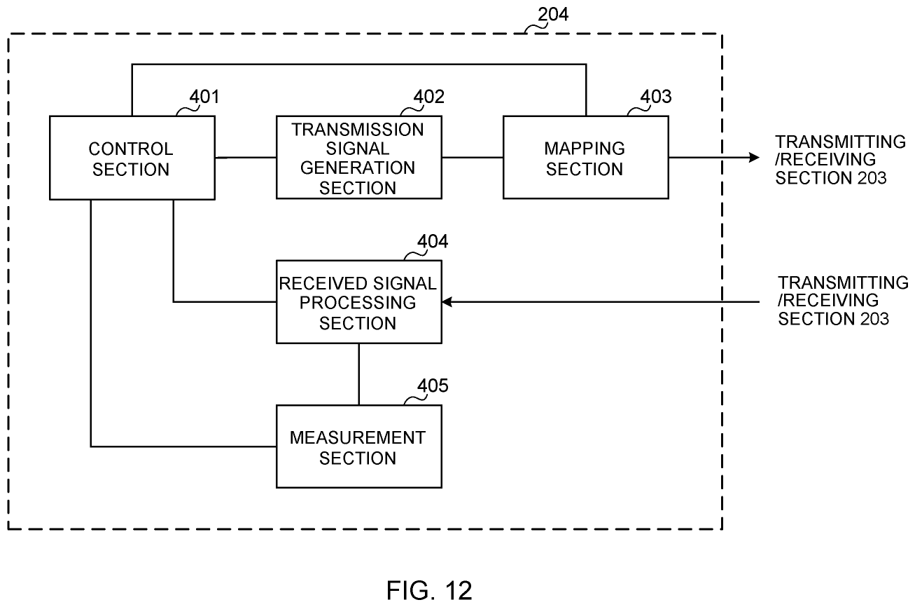

FIG. 12 is a diagram showing one example of a function configuration of the user terminal according to one Embodiment of the present invention. In addition, this example mainly illustrates function blocks of a characteristic portion in this Embodiment, and the user terminal 20 is assumed to have other function blocks required for radio communication.

The baseband signal processing section 204 that the user terminal 20 has is provided with at least a control section 401, transmission signal generating section 402, mapping section 403, received signal processing section 404, and measurement section 405. In addition, these components are essentially included in the user terminal 20, and a part or the whole of the components may not be included in the baseband signal processing section 204.

The control section 401 performs control of the entire user terminal 20. The control section 401 is capable of being comprised of a controller, control circuit or control apparatus explained based on the common recognition in the technical field according to the present invention.

For example, the control section 401 controls generation of signals by the transmission signal generating section 402, and allocation of signals by the mapping section 403. Further, the control section 401 controls reception processing of signals by the received signal processing section 404, and measurement of signals by the measurement section 405.

The control section 401 acquires the downlink control signal (signal transmitted on the PDCCH/EPDCCH) and downlink data signal (signal transmitted on the PDSCH) transmitted from the radio base station 10, from the received signal processing section 404. Based on the downlink control signal, result obtained by determining the necessity of retransmission control to the downlink data signal, and the like, the control section 401 controls generation of the uplink control signal (e.g., receipt confirmation information, etc.) and uplink data signal.

The control section 401 controls to form a transmission beam and/or reception beam, using digital BF (e.g., precoding) by the baseband signal processing section 204 and/or analog BF (e.g., phase rotation) by the transmitting/receiving section 203.

For example, the control section 401 receives at least one beam directed to the terminal, among a plurality of beams transmitted in a predetermined period (e.g., sweep period).

The control section 401 controls to perform reception processing, while assuming that the synchronization signal and broadcast channel with same beam (beam pattern) applied are mapped to the same time region in different transmission time intervals.

Further, the control section 401 controls to perform reception processing, while assuming that PSS and SSS are subjected to FDM on the same symbol, and that the PBCH is mapped to time resources of the same symbol number as that of PSS/SSS in a subframe (or slot) different from PSS/SSS. At this point, the section 401 may monitor, while assuming that the PBCH has the same bandwidth as the total bandwidth in performing FDM on PSS/SSS.

Furthermore, the control section 401 may control reception processing, while assuming that PBCH and RS for PBCH demodulation are subjected to FDM, and that the RS for PBCH demodulation is mapped to the same time resource as that of the PBCH. In addition, the section may perform reception processing, while assuming that the PBCH has a bandwidth different from the total bandwidth in performing FDM on PSS and SSS. Further, different transmission bandwidths (sequence lengths) may be applied to PSS and SSS.

Still furthermore, the control section 401 may control reception processing, while assuming that PSS and SSS are subjected to TDM on contiguous symbols (Aspect 2). For example, the section performs reception processing, while assuming that PSS and SSS are subjected to TDM on contiguous symbols, and that the PBCH is mapped respectively to time regions of the same symbol numbers as two symbol numbers of PSS and SSS in a subframe (or slot) different from PSS/SSS. The section may perform reception processing on the assumption that transmission bandwidths of the PSS, SSS and PBCH are configured to be the same, or may perform reception processing on the assumption that RS for PBCH demodulation and PBCH are mapped to the same symbol. Alternatively, the section may perform reception processing, on the assumption that resource allocation is made so that any of transmission bandwidths differ in transmission bandwidths of the PSS and SSS, transmission bandwidths of the PSS and PBCH, and transmission bandwidths of the SSS and PBCH. Further, the section may perform reception processing, while assuming that the RS for PBCH demodulation is subjected to TDM with the PBCH.

Moreover, the control section 401 may control reception processing, while assuming that PSS and SSS are subjected to TDM on resources of the same symbol number in different subframes (or slots) (Aspect 3). At this point, the section may perform reception processing on the assumption that the PSS, SSS and PBCH have the same bandwidth. Further, the section may perform reception processing on the assumption that the PBCH transmitted in one transmission beam is mapped to one OFDM symbol to match with the number of transmission symbols of each beam pattern for transmitting the PSS and SSS.

Further, in single-beam operation or multi-beam operation with the low number of beam patterns, the control section 401 may control reception processing, while assuming that PSS/SSS and PBCH are mapped from predetermined (for example, last) OFDM symbols in respective subframes (or slots) (Modification).

Furthermore, the control section 401 controls reception operation so as to monitor resources determined corresponding to a detection result of the synchronization signal and/or broadcast channel received from the radio base station prior to transmission of a random access preamble to receive the paging channel.

Based on instructions from the control section 401, the transmission signal generating section 402 generates uplink signals (uplink control signal, uplink data signal, uplink reference signal, etc.) to output to the mapping section 403. The transmission signal generating section 402 is capable of being comprised of a signal generator, signal generating circuit or signal generating apparatus explained based on the common recognition in the technical field according to the present invention.

For example, based on instructions from the control section 401, the transmission signal generating section 402 generates the uplink control signal about receipt confirmation information and channel state information (CSI). Further, based on instructions from the control section 401, the transmission signal generating section 402 generates the uplink data signal. For example, when the downlink control signal notified from the radio base station 10 includes the UL grant, the transmission signal generating section 402 is instructed to generate the uplink data signal from the control section 401.

Based on instructions from the control section 401, the mapping section 403 maps the uplink signal generated in the transmission signal generating section 402 to radio resources to output to the transmitting/receiving section 203. The mapping section 403 is capable of being comprised of a mapper, mapping circuit or mapping apparatus explained based on the common recognition in the technical field according to the present invention.

The received signal processing section 404 performs reception processing (e.g. demapping, demodulation, decoding, etc.) on the received signal input from the transmitting/receiving section 203. Herein, for example, the received signal is the downlink signal (downlink control signal, downlink data signal, downlink reference signal, etc.) transmitted from the radio base station 10. The received signal processing section 404 is capable of being comprised of a signal processor, signal processing circuit or signal processing apparatus explained based on the common recognition in the technical field according to the present invention. Further, the received signal processing section 404 is capable of constituting the receiving section according to the present invention.

Based on instructions from the control section 401, the received signal processing section 404 receives the synchronization signal and broadcast channel to which the radio base station applies beam forming to transmit. Particularly, the section receives the synchronization signal and broadcast channel allocated to at least one of a plurality of time regions (e.g., symbols) constituting a predetermined transmission time interval (e.g., subframe or slot).

Further, based on instructions from the control section 401, the received signal processing section 404 may receive the paging message (PCH) and common control channel for scheduling the massage in different symbols or different subframes.

The received signal processing section 404 outputs the information decoded by the reception processing to the control section 401. For example, the received signal processing section 404 outputs the broadcast information, system information, RRC signaling, DCI and the like to the control section 401. Further, the received signal processing section 404 outputs the received signal and signal subjected to the reception processing to the measurement section 405.

The measurement section 405 performs measurement on the received signal. For example, the measurement section 405 performs measurement using RS for beam forming transmitted from the radio base station 10. The measurement section 405 is capable of being comprised of a measurement device, measurement circuit or measurement apparatus explained based on the common recognition in the technical field according to the present invention.

For example, the measurement section 405 may measure received power (e.g., RSRP), received quality (e.g., RSRQ, received SINR), channel state and the like of the received signal. The measurement result may be output to the control section 401.

### (Hardware Configuration)

In addition, the block diagrams used in explanation of the above-mentioned Embodiment show blocks on a function-by-function basis. These function blocks (configuration sections) are actualized by any combination of hardware and/or software. Further, the means for actualizing each function block is not limited particularly. In other words, each function block may be actualized by a single apparatus combined physically and/or logically, or two or more apparatuses that are separated physically and/or logically are connected directly and/or indirectly (e.g., by cable and/or radio), and each function block may be actualized by a plurality of these apparatuses.

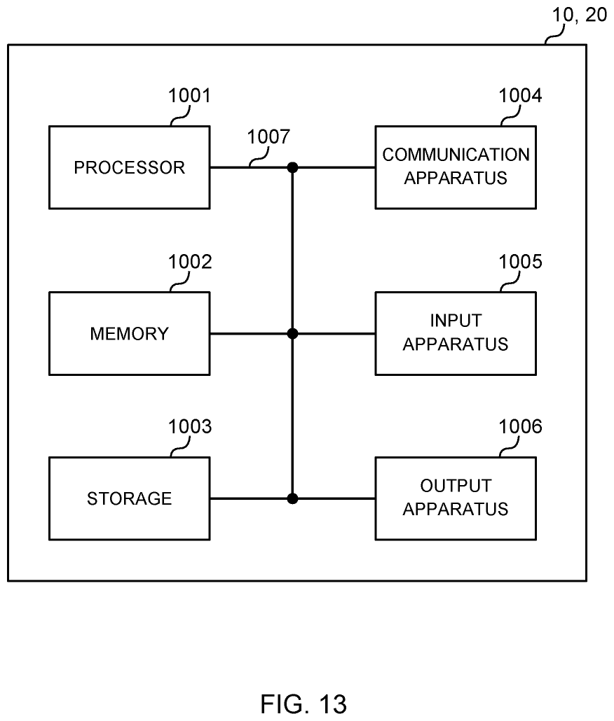

For example, each of the radio base station, user terminal and the like in one Embodiment of the present invention may function as a computer that performs the processing of the radio communication method of the invention. FIG. 13 is a diagram showing one example of a hardware configuration of each of the radio base station and user terminal according to one Embodiment of the invention. Each of the radio base station 10 and user terminal 20 as described above may be physically configured as a computer apparatus including a processor 1001, memory 1002, storage 1003, communication apparatus 1004, input apparatus 1005, output apparatus 1006, bus 1007 and the like.

In addition, in the following description, it is possible to replace the letter of “apparatus” with a circuit, device, unit and the like to read. With respect to each apparatus shown in the figure, the hardware configuration of each of the radio base station 10 and the user terminal 20 may be configured so as to include one or a plurality of apparatuses, or may be configured without including a part of apparatuses.

For example, a single processor 1001 is shown in the figure, but a plurality of processors may exist. Further, the processing may be executed by a single processor, or may be executed by one or more processors at the same time, sequentially or by another technique. In addition, the processor 1001 may be implemented on one or more chips.

For example, each function in the radio base station 10 and user terminal 20 is actualized in a manner such that predetermined software (program) is read on the hardware of the processor 1001, memory 1002 and the like, and that the processor 1001 thereby performs computations, and controls communication by the communication apparatus 1004, and read and/or write of data in the memory 1002 and storage 1003.

For example, the processor 1001 operates an operating system to control the entire computer. The processor 1001 may be comprised of a Central Processing Unit (CPU) including interfaces with peripheral apparatuses, control apparatus, computation apparatus, register and the like. For example, the above-mentioned baseband signal processing section 104 (204), call processing section 105 and the like may be actualized by the processor 1001.

Further, the processor 1001 reads the program (program code), software module, data and the like on the memory 1002 from the storage 1003 and/or the communication apparatus 1004, and according thereto, executes various kinds of processing. Used as the program is a program that causes the computer to execute at least a part of operation described in the above-mentioned Embodiment. For example, the control section 401 of the user terminal 20 may be actualized by a control program stored in the memory 1002 to operate in the processor 1001, and the other function blocks may be actualized similarly.

The memory 1002 is a computer-readable storage medium, and for example, may be comprised of at least one of ROM (Read Only Memory), EPROM (Erasable Programmable ROM), EEPROM (Electrically EPROM), RAM (Random Access Memory) and other proper storage media. The memory 1002 may be called the register, cache, main memory (main storage apparatus) and the like. The memory 1002 is capable of storing the program (program code), software module and the like executable to implement the radio communication method according to one Embodiment of the present invention.

The storage 1003 is a computer-readable storage medium, and for example, may be comprised of at least one of a flexible disk, floppy (Registered Trademark) disk, magneto-optical disk (e.g., compact disk (CD-ROM (Compact Disc ROM), etc.), digital multi-purpose disk, Blu-ray (Registered Trademark) disk), removable disk, hard disk drive, smart card, flash memory device (e.g., card, stick, key drive), magnetic stripe, database, server and other proper storage media. The storage 1003 may be called an auxiliary storage apparatus.

The communication apparatus 1004 is hardware (transmitting/receiving device) to perform communication between computers via a wired and/or wireless network, and for example, is also referred to as a network device, network controller, network card, communication module and the like. For example, in order to actualize Frequency Division Duplex (FDD) and/or Time Division Duplex (TDD), the communication apparatus 1004 may be comprised by including a high-frequency switch, duplexer, filter, frequency synthesizer and the like. For example, the transmitting/receiving antenna 101 (201), amplifying section 102 (202), transmitting/receiving section 103 (203), communication path interface 106 and the like as described above may be actualized by the communication apparatus 1004.

The input apparatus 1005 is an input device (e.g., keyboard, mouse, microphone, switch, button, sensor, etc.) that receives input from the outside. The output apparatus 1006 is an output device (e.g., display, speaker, LED (Light Emitting Diode) lamp, etc.) that performs output to the outside. In addition, the input apparatus 1005 and output apparatus 1006 may be an integrated configuration (e.g., touch panel).

Further, each apparatus of the processor 1001, memory 1002 and the like is connected on the bus 1007 to communicate information. The bus 1007 may be comprised of a single bus, or may be comprised of different buses between apparatuses.

Furthermore, each of the radio base station 10 and user terminal 20 may be configured by including hardware such as a microprocessor, Digital Signal Processor (DSP), ASIC (ApplicatioN Specific Integrated Circuit), PLD (Programmable Logic Device), and FPGA (Field Programmable Gate Array), or a part or the whole of each function block may be actualized by the hardware. For example, the processor 1001 may be implemented by at least one of the hardware.

### (Modification)

In addition, the term explained in the present Description and/or the term required to understand the present Description may be replaced with a term having the same or similar meaning. For example, the channel and/or the symbol may be a signal (signaling). Further, the signal may be a message. The reference signal is capable of being abbreviated as RS (Reference Signal), and according to the standard to apply, may be called a pilot, pilot signal and the like. Furthermore, a component carrier (CC) may be called a cell, frequency carrier, carrier frequency and the like.

Further, the radio frame may be comprised of one or a plurality of frames in the time domain. The one or each of the plurality of frames constituting the radio frame may be called a subframe. Furthermore, the subframe may be comprised of one or a plurality of slots in the time domain. Still furthermore, the slot may be comprised of one or a plurality of symbols (OFDM (Orthogonal Frequency Division Multiplexing) symbols, SC-FDMA (Single Carrier Frequency Division Multiple Access) symbols and the like) in the time domain.

Each of the radio frame, subframe, slot and symbol represents a time unit in transmitting a signal. For the radio frame, subframe, slot and symbol, another name corresponding to each of them may be used. For example, one subframe may be called Transmission Time Interval (TTI), a plurality of contiguous subframes may be called TTI, or one slot may be called TTI. In other words, the subframe and TTI may be the subframe (1 ms) in existing LTE, may be a frame (e.g., 1 to 13 symbols) shorter than 1 ms, or may be a frame longer than 1 ms.

Herein, for example, the TTI refers to a minimum time unit of scheduling in radio communication. For example, in the LTE system, the radio base station performs scheduling for allocating radio resources (frequency bandwidth, transmit power and the like capable of being used in each user terminal) to each user terminal in a TTI unit. In addition, the definition of the TTI is not limited thereto. The TTI may be a transmission time unit of a data packet (transport block) subjected to channel coding, or may be a processing unit of scheduling, link adaptation and the like.

The TTI having a time length of 1 ms may be called ordinary TTI (TTI in LTE Rel.8-12), normal TTI, long TTI, ordinary subframe, normal subframe, long subframe or the like. TTI shorter than the ordinary TTI may be called reduced TTI, short TTI, reduced subframe, short subframe or the like.

The resource block (RB) is a resource allocation unit in the time domain and frequency domain, and may include one or a plurality of contiguous subcarriers in the frequency domain. Further, the RB may include one or a plurality of symbols in the time domain, and may have a length of 1 slot, 1 subcarrier, or 1 TTI. Each of 1 TTI and 1 subframe may be comprised of one or a plurality of resource blocks. In addition, the RB may be called a physical resource block (PRB: Physical RB), PRB pair, RB pair and the like.

Further, the resource block may be comprised of one or a plurality of resource elements (RE: Resource Element). For example, 1 RE may be a radio resource region of 1 subcarrier and 1 symbol.

In addition, structures of the above-mentioned radio frame, subframe, slot, symbol and the like are only illustrative. For example, it is possible to modify, in various manners, configurations of the number of subframes included in the radio frame, the number of slots included in the subframe, the numbers of symbols and RBs included in the slot, the number of subcarriers included in the RB, the number of symbols inside the TTI, the symbol length, the cyclic prefix (CP) length and the like.

Further, the information, parameter and the like explained in the present Description may be expressed by an absolute value, may be expressed by a relative value from a predetermined value, or may be expressed by another corresponding information. For example, the radio resource may be indicated by a predetermined index. Further, equations using these parameters and the like may be different from those explicitly disclosed in the present Description.

The names used in the parameter and the like in the present Description are not restrictive in any respects. For example, it is possible to identify various channels (PUCCH (Physical Uplink Control Channel), PDCCH (Physical Downlink Control Channel) and the like) and information elements, by any suitable names, and therefore, various names assigned to these various channels and information elements are not restrictive in any respects.

The information, signal and the like explained in the present Description may be represented by using any of various different techniques. For example, the data, order, command, information, signal, bit, symbol, chip and the like capable of being described over the entire above-mentioned explanation may be represented by voltage, current, electromagnetic wave, magnetic field or magnetic particle, optical field or photon, or any combination thereof.

Further, the information, signal and the like are capable of being output from a higher layer to a lower layer, and/or from the lower layer to the higher layer. The information, signal and the like may be input and output via a plurality of network nodes.

The input/output information, signal and the like may be stored in a particular place (e.g., memory), or may be managed with a management table. The input/output information, signal and the like are capable of being rewritten, updated or edited. The output information, signal and the like may be deleted. The input information, signal and the like may be transmitted to another apparatus.

Notification of the information is not limited to the Aspects/Embodiments described in the present Description, and may be performed by another method. For example, notification of the information may be performed using physical layer signaling (e.g., Downlink Control Information (DCI), Uplink Control Information (UCI)), higher layer signaling (e.g., RRC (Radio Resource Control) signaling, broadcast information (Master Information Block (MIB), System Information Block (SIB) and the like), MAC (Medium Access Control) signaling), other signals, or combination thereof.

In addition, the physical layer signaling may be called L1/L2 (Layer 1/Layer 2) control information (L1/L2 control signal), L1 control information (L1 control signal) and the like. Further, the RRC signaling may be called RRC message, and for example, may be RRC connection setup (Rrcconnectionsetup) message, RRC connection reconfiguration (Rrcconnectionreconfiguration) message, and the like. Furthermore, for example, the MAC signaling may be notified by MAC Control Element (MAC CE).

Further, notification of predetermined information (e.g., notification of “being X”) is not limited to notification that is performed explicitly, and may be performed implicitly (e.g., notification of the predetermined information is not performed, or by notification of different information).

The decision may be made with a value (“0” or “1”) expressed by 1 bit, may be made with a Boolean value represented by true or false, or may be made by comparison with a numerical value (e.g., comparison with a predetermined value).

Irrespective of that the software is called software, firmware, middle-ware, micro-code, hardware descriptive term, or another name, the software should be interpreted widely to mean a command, command set, code, code segment, program code, program, sub-program, software module, application, software application, software package, routine, sub-routine, object, executable file, execution thread, procedure, function and the like.

Further, the software, command, information and the like may be transmitted and received via a transmission medium. For example, when the software is transmitted from a website, server or another remote source using wired techniques (coaxial cable, optical fiber cable, twisted pair, Digital Subscriber Line (DSL) and the like) and/or wireless techniques (infrared, microwave and the like), these wired techniques and/or wireless techniques are included in the definition of the transmission medium.

The terms of “system” and “network” used in the present Description are used interchangeably.

In the present Description, the terms of “Base Station (BS)”, “radio base station”, “eNB”, “cell”, “sector”, “cell group”, “carrier” and “component carrier” are capable of being used interchangeably. There is the case where the base station is called by the terms of fixed station, NodeB, eNodeB (eNB), access point, transmission point, reception point, femto-cell, small cell and the like.

The base station is capable of accommodating one or a plurality of (e.g. three) cells (also called the sector). When the base station accommodates a plurality of cells, the entire coverage area of the base station is capable of being divided into a plurality of smaller areas, and each of the smaller areas is also capable of providing communication services by a base station sub-system (e.g., small base station (RRH: Remote Radio Head) for indoor use). The term of “cell” or “sector” refers to a part or the whole of coverage area of the base station and/or base station sub-system that performs communication services in the coverage.

In the present Description, the terms of “Mobile Station (MS)”, “user terminal”, “User Equipment (UE)”, and “terminal” are capable of being used interchangeably. There is the case where the base station is called by the terms of fixed station, NodeB, eNodeB (eNB), access point, transmission point, reception point, femto-cell, small cell and the like.

There is the case where the Mobile Station may be called using a subscriber station, mobile unit, subscriber unit, wireless unit, remote unit, mobile device, wireless device, wireless communication device, remote device, mobile subscriber station, access terminal, mobile terminal, wireless terminal, remote terminal, handset, user agent, mobile client, client, or some other suitable terms, by a person skilled in the art.

Further, the radio base station in the present Description may be read with the user terminal. For example, each Aspect/Embodiment of the present invention may be applied to a configuration where communication between the radio base station and the user terminal is replaced with communication among a plurality of user terminals (D2D: Device-to-Device). In this case, the functions that the above-mentioned radio base station 10 has may be the configuration that the user terminal 20 has. Further, the words of “up”, “down” and the like may be read with “side”. For example, the uplink channel may be read with a side channel.

Similarly, the user terminal in the present Description may be read with the radio base station. In this case, the functions that the above-mentioned user terminal 20 has may be the configuration that the radio base station 10 has.

In the present Description, particular operation performed by the base station may be performed by an upper node thereof in some case. In a network comprised of one or a plurality of network nodes having the base station, it is obvious that various operations performed for communication with the terminal are performed by the base station, one or more Network Nodes (e.g., MME (Mobility Management Entity), S-GW (Serving-Gateway) and the like are considered, but the invention is not limited thereto) except the base station, or combination thereof.

Each Aspect/Embodiment explained in the present Description may be used alone, may be used in combination, or may be switched and used according to execution. Further, with respect to the processing procedure, sequence, flowchart and the like of each Aspect/Embodiment explained in the present Description, unless there is a contradiction, the order may be changed. For example, with respect to the methods explained in the present Description, elements of various steps are presented in illustrative order, and are not limited to the presented particular order.

Each Aspect/Embodiment explained in the present Description may be applied to LTE (Long Term Evolution), LTE-A (LTE-Advanced), LTE-B (LTE-Beyond), SUPER 3G, IMT-AdvaNced, 4G (4th generation mobile communication system), 5G (5th generation mobile communication system), FRA (Future Radio Access), New-RAT (Radio Access Technology), NR (New Radio), NX (New radio access), FX (Future Generation Radio access), GSM (Registered Trademark) (Global System for Mobile Communications), CDMA 2000, UMB (Ultra Mobile Broadband), IEEE 802.11 (Wi-Fi (Registered Trademark)), IEEE 802.16 (WiMAX (Registered Trademark)), IEEE 802.20, UWB (Ultra-WideBand), Bluetooth (Registered Trademark), system using another proper radio communication method and/or the next-generation system extended based thereon.

The description of “based on” used in the present Description does not mean “based on only”, unless otherwise specified. In other words, the description of “based on” means both of “based on only” and “based on at least”.

Any references to elements using designations of “first”, “second” and the like used in the present Description are not intended to limit the amount or order of these elements overall. These designations are capable of being used in the present Description as the useful method to distinguish between two or more elements. Accordingly, references of first and second elements do not mean that only two elements are capable of being adopted, or that the first element should be prior to the second element in any manner.

There is the case where the term of “determining” used in the present Description includes various types of operation. For example, “determining” may be regarded as “determining” calculating, computing, processing, deriving, investigating, looking up (e.g., search in a table, database or another data structure), ascertaining and the like. Further, “determining” may be regarded as “determining” receiving (e.g., receiving information), transmitting (e.g., transmitting information), input, output, accessing (e.g., accessing data in memory) and the like. Furthermore, “determining” may be regarded as “determining” resolving, selecting, choosing, establishing, comparing and the like. In other words, “determining” may be regarded as “determining” some operation.

The terms of “connected” and “coupled” used in the present Description or any modifications thereof mean direct or indirect every connection or coupling among two or more elements, and are capable of including existence of one or more intermediate elements between two mutually “connected” or “coupled” elements. Coupling or connection between elements may be physical, may be logical or may be combination thereof. In the case of using in the present Description, it is possible to consider that two elements are mutually “connected” or “coupled”, by using one or more electric wires, cable and/or print electric connection, and as some non-limited and non-inclusive examples, electromagnetic energy such as electromagnetic energy having wavelengths in a radio frequency region, microwave region and light (both visible and invisible) region.

In the case of using “including”, “comprising” and modifications thereof in the present Description or the scope of the claims, as in the term of “provided with”, these terms are intended to be inclusive. Further, the term of “or” used in the present Description or the scope of the claims is intended to be not exclusive OR.

As described above, the present invention is described in detail, but it is obvious to a person skilled in the art that the invention is not limited to the Embodiments described in the present Description. The invention is capable of being carried into practice as modified and changed aspects without departing from the subject matter and scope of the invention defined by the descriptions of the scope of the claims. Accordingly, the descriptions of the present Description are intended for illustrative explanation, and do not have any restrictive meaning to the invention.

The present application is based on Japanese Patent Application No. 2016-192337 filed on Sep. 29, 2016, entire content of which is expressly incorporated by reference herein.

1. A user terminal comprising:
a receiving section that receives a synchronization signal and a broadcast channel allocated to at least one of a plurality of time regions constituting a given transmission time interval; and
a control section that controls reception of the synchronization signal and the broadcast channel,
wherein the control section controls reception processing, while assuming that the synchronization signal and the broadcast channel are allocated to a same time region in different transmission time intervals.

2. The user terminal according to claim 1, wherein the synchronization signal is comprised of a first synchronization signal and a second synchronization signal that are subjected to frequency division multiplexing in the same time region.

3. The user terminal according to claim 1, wherein the synchronization signal is comprised of a first synchronization signal and a second synchronization signal that are subjected to time division multiplexing in a same transmission time interval.

4. The user terminal according to claim 1, wherein the synchronization signal is comprised of a first synchronization signal and a second synchronization signal allocated to the same time region in different transmission time intervals.

5. The user terminal according to claim 1, wherein the control section controls demodulation of the broadcast channel, using a reference signal subjected to frequency division multiplexing with the broadcast channel.

6. A radio communication method of a user terminal for communicating with a radio base station, comprising:
receiving a synchronization signal and a broadcast channel allocated to at least one of a plurality of time regions constituting a given transmission time interval; and
controlling reception of the synchronization signal and the broadcast channel,
wherein the user terminal controls reception processing, while assuming that the synchronization signal and the broadcast channel are allocated to a same time region in different transmission time intervals.

7. The user terminal according to claim 2, wherein the control section controls demodulation of the broadcast channel, using a reference signal subjected to frequency division multiplexing with the broadcast channel.

8. The user terminal according to claim 3, wherein the control section controls demodulation of the broadcast channel, using a reference signal subjected to frequency division multiplexing with the broadcast channel.

9. The user terminal according to claim 4, wherein the control section controls demodulation of the broadcast channel, using a reference signal subjected to frequency division multiplexing with the broadcast channel.
